(19) United States
(12) Patent Application Publication
(10) Pub. No.: US 2026/0102926 A1
(43) Pub. Date: Apr. 16, 2026

(54) END EFFECTOR OF A HUMANOID ROBOT

(71) Applicant: Figure AI Inc., San Jose, CA (US)

(72) Inventors: Marc Baroudi, San Jose, CA (US); Michael Stevens, San Jose, CA (US); Jake Goldsmith, San Jose, CA (US); Keith Wakeham, San Jose, CA (US); Jose Domingo Briones Bravo, San Jose, CA (US)

(21) Appl. No.: 19/355,393

(22) Filed: Oct. 10, 2025

Related U.S. Application Data
(63) Continuation-in-part of application No. 19/347,690, filed on Oct. 1, 2025.
(60) Provisional application No. 63/705,715, filed on Oct. 10, 2024.
(60) Provisional application No. 63/706,768, filed on Oct. 14, 2024.
(60) Provisional application No. 63/828,916, filed on Jun. 23, 2025.

(51) Int. Cl. B25J 15/00; B25J 19/04

(52) U.S. Cl. CPC B25J 15/0009; B25J 19/04

(57) ABSTRACT

The present disclosure provides a humanoid robot comprising a torso, a head coupled to the torso, an arm assembly coupled to the torso, and an end effector coupled to the arm assembly at a distal end of the arm assembly. The end effector has a palmer side and a dorsal side and includes a thumb assembly having at least three degrees of freedom, a first finger assembly having at least two degrees of freedom, and a vision sensor coupled to a portion of the end effector. The vision sensor is configured to have a field of view that includes a majority of the palmer side of said end effector, and whereby said field of view enables the vision sensor to detect information about contact between an object and one or more of: (i) an extent of the thumb assembly, and (ii) an extent of the first finger assembly.

### CROSS REFERENCE TO RELATED APPLICATIONS

This application is: (i) a continuation-in-part of U.S. patent application Ser. No. 19/347,690, filed Oct. 1, 2025, and (ii) claims the benefit of and priority to U.S. Provisional Patent Application Nos. 63/705,715, filed Oct. 10, 2024, 63/706,768, filed Oct. 14, 2024, and 63/828,916 filed Jun. 23, 2025, each of which is expressly incorporated by reference herein in its entirety.

### TECHNICAL FIELD

This disclosure relates to an end effector for a robot, specifically a vision sensor assembly for said end effector.

### BACKGROUND

Humanoid robots are designed to perform a wide range of tasks traditionally done by humans, including the handling and manipulation of objects. To perform these tasks effectively, particularly those requiring fine motor control and dexterity, robust perceptual capabilities are critical. However, conventional robotic systems often suffer from perceptual limitations, especially during manipulation tasks. Many conventional robots rely on vision sensors located in the head or torso to guide their actions. A significant drawback of this configuration is that the sensor's line of sight can be easily obscured by the robot's own body, such as its arms or the end effectors themselves, or by other objects in the environment. This occlusion creates blind spots, particularly during grasping operations, which limits the robot's ability to perceive critical information about the interaction between the end effector and an object. Furthermore, existing systems are often dependent on ambient lighting, which can be inconsistent and affect sensor performance. Another limitation is that conventional end effectors frequently rely on a single sensing modality, such as vision or touch, but not a fusion of both. This reliance on a single data source limits the robot's ability to perform complex manipulations that require delicate touch and precise visual feedback. Consequently, there is a need for an improved end effector design that overcomes these perceptual limitations to enhance dexterity and enable more reliable and sophisticated manipulation.

### SUMMARY

The presently disclosed subject matter is directed to a humanoid robot comprising a torso, a head coupled to the torso, an arm assembly coupled to the torso at a proximal end of the arm assembly, and an end effector coupled to the arm assembly at a distal end of the arm assembly. The end effector has a palmer side and a dorsal side and includes a thumb assembly having at least three degrees of freedom, a first finger assembly having at least two degrees of freedom, and a vision sensor coupled to a portion of the end effector. The vision sensor is configured to have a field of view that includes a majority of the palmer side of said end effector, and whereby said field of view enables the vision sensor to detect information about contact between an object and one or more of: (i) an extent of the thumb assembly, and (ii) an extent of the first finger assembly.

The presently disclosed subject matter is directed to a humanoid robot comprising a torso, a head coupled to the torso, an arm assembly coupled to the torso, and an end effector coupled to the arm assembly. The end effector includes a first finger assembly having: (i) a respective operational space, (ii) a first energy attenuation member affixed to a portion of the first finger assembly, and (iii) a respective distal assembly with a respective tactile sensor positioned therein, a thumb assembly positioned adjacent to the first finger assembly and having: (i) a respective operational space, (ii) a second energy attenuation member affixed to a portion of the thumb assembly, and (iii) a respective distal assembly with a respective tactile sensor positioned therein, and a vision sensor positioned near both the thumb assembly and the finger assembly and having a field of view that includes the respective operational space of the first finger and at least a majority of the respective operational space of the thumb.

The presently disclosed subject matter is directed to a humanoid robot comprising a torso, a head coupled to the torso, an arm assembly coupled to the torso, and an end effector coupled to the arm assembly. The end effector includes a thumb assembly coupled to a first portion of the end effector, a first finger assembly coupled to a second portion of the end effector, a sensor mounting frame coupled to a third portion of the end effector that is positioned between a distal extent of the arm and a majority of the first finger assembly, and a vision sensor mounted to the sensor mounting frame and including an imaging detector, a lens that overlies and protects the imaging detector, and an illumination source positioned near the image detector.

The presently disclosed subject matter is directed to a humanoid robot comprising an arm assembly and an end effector coupled to a distal end of the arm assembly. The end effector includes a thumb assembly, at least one finger assembly, and an end effector housing having a palmer side and a dorsal side. The humanoid robot includes a vision sensor positioned on the palmer side of the end effector housing between a distal portion of the arm assembly and a knuckle assembly of the at least one finger assembly, the vision sensor configured to obtain information about contact between an object and an extent of either the thumb assembly or the at least one finger assembly.

The presently disclosed subject matter is directed to a method of controlling a humanoid robot end effector comprising providing an end effector having a thumb assembly, at least one finger assembly, and a vision sensor positioned on a palmer side of the end effector, capturing visual information with the vision sensor directed toward the thumb assembly and the at least one finger assembly, detecting contact between an object and an extent of either the thumb assembly or the at least one finger assembly based on the visual information, and controlling movement of the thumb assembly and the at least one finger assembly based on the detected contact.

The presently disclosed subject matter is directed to an end effector for a humanoid robot comprising an end effector housing having a palmer side and a dorsal side, a thumb assembly coupled to the end effector housing, at least one finger assembly coupled to the end effector housing, a vision sensor assembly positioned on the palmer side of the end effector housing, the vision sensor assembly including an imager, a lens overlying the imager, and an illumination source positioned near the imager, and a control assembly configured to control motor assemblies of the thumb assembly and the at least one finger assembly based on information from the vision sensor assembly.

The presently disclosed subject matter is directed to a vision sensor assembly for a robotic end effector comprising a sensor housing including a center aperture, a rim surrounding the center aperture, and a channel formed in the rim, an imager configured to be received within the sensor housing with a line of sight directed outward through the center aperture, an illumination source configured to be received within the channel in a plane perpendicular to the line of sight of the imager, and a sensor mounting frame configured to couple the sensor housing to an end effector housing, wherein the vision sensor assembly is positioned to direct the line of sight toward thumb and finger assemblies of the end effector.

The presently disclosed subject matter is directed to a system for robotic manipulation comprising a humanoid robot having an arm assembly, an end effector coupled to the arm assembly, the end effector including a thumb assembly, at least one finger assembly, and a vision sensor positioned to observe the thumb assembly and the at least one finger assembly, tactile sensor assemblies positioned in the thumb assembly and the at least one finger assembly, and a control system configured to receive visual information from the vision sensor and tactile information from the tactile sensor assemblies, and to control movement of the thumb assembly and the at least one finger assembly based on a fusion of the visual information and the tactile information.

The presently disclosed subject matter is directed to a protective cover system for a robotic end effector comprising a detachably removable protective cover configured as a form-fitting glove arranged external to an end effector housing, a main portion configured to substantially cover a main enclosure of the end effector housing, thumb and finger portions extending from the main portion and configured to substantially cover thumb and finger assemblies, and a sensor region shaped to accommodate a vision sensor without obstructing a field of view of the vision sensor, wherein the protective cover is configured to stretch as the finger assemblies and thumb assembly bend at joints.

The presently disclosed subject matter is directed to a method of manufacturing a humanoid robot end effector comprising providing an end effector housing having a palmer side and a dorsal side, coupling a thumb assembly and at least one finger assembly to the end effector housing, forming a sensor opening in the palmer side of the end effector housing, positioning a vision sensor assembly in the sensor opening, the vision sensor assembly including an imager, a lens, and an illumination source, orienting the vision sensor assembly such that a line of sight is directed at a downward-facing angle with respect to a horizontal plane and toward the thumb assembly and the at least one finger assembly, and coupling a control assembly to the vision sensor assembly and to motor assemblies of the thumb assembly and the at least one finger assembly.

In some embodiments, a vision sensor is positioned on a palmer side of the end effector, proximate to a wrist of an arm assembly and between a distal end of the arm assembly and a first finger assembly. In some embodiments, as determined while the humanoid robot is in an extended state, the vision sensor is oriented at a downward-facing angle of about 45 to 70 degrees (e.g., about 46.3 to 69.5 degrees) with respect to a horizontal plane and at an inward-facing angle of about 12 to 19 degrees (e.g., about 12.2 to 18.4 degrees) with respect to a vertical plane, such that its field of view includes at least a portion of the palmer side of the end effector.

In some embodiments, the vision sensor comprises an imager and a lens, and further includes an illumination source, such as an LED light ring, arranged to illuminate at least a portion of the field of view, including the respective operational spaces of a thumb assembly and the first finger assembly. In some embodiments, a translucent lighting cover is configured to protect the illumination source and diffuse emitted light. In some embodiments, the end effector further comprises tactile sensors, such as strain gauges, positioned at a distal end of the thumb assembly and/or the finger assembly.

In some embodiments, a control assembly is configured to control movement of the first finger assembly and the thumb assembly based on a fusion of visual information from the vision sensor and tactile feedback from the tactile sensors to enable delicate manipulation in a closed-loop feedback system. In some embodiments, information derived from the vision sensor is also used in combination with information derived from other sensors for locomotion planning.

In some embodiments, the humanoid robot further comprises a detachably removable protective cover, such as a form-fitting glove, configured to overlie a majority of the end effector. The protective cover includes a sensor region formed therein that does not cover or obstruct the field of view of the vision sensor. In some embodiments, the protective cover is detachably secured to the end effector via an elastic loop configured to be secured in an attachment channel of a wrist actuator housing. In some embodiments, energy attenuation members are positioned beneath the protective cover to provide energy absorption properties and reduce pinch points. In some embodiments, the end effector further includes a heat sink positioned at a dorsal side. In some embodiments, the vision sensor comprises a first imaging detector, and a head of the humanoid robot includes a second imaging detector that is identical to the first imaging detector.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, like reference numerals refer to the same or similar elements. This convention is maintained throughout the drawings for consistency.

FIG. 1 is a diagram illustrating an environment and a network in which one or more humanoid robots may operate, connect, command and/or be commanded by, control and/or be controlled by, and/or interact;

FIG. 2 is a block diagram illustrating components of the humanoid robot of FIG. 1;

FIG. 3A is a diagram illustrating actuators contained within the humanoid robot of FIG. 1-2 and the corresponding rotational axes of said actuators, with arms in an extended state;

FIG. 3B is a perspective view of a humanoid robot of FIGS. 1-3A in a neutral state;

FIG. 4 is a perspective view of one of the end effectors included in the robot of FIGS. 1-3B, wherein the end effector includes: (i) a thumb assembly, (ii) at least one finger assembly (e.g., four finger assemblies), (iii) an electronics assembly including a vision sensor, and (iv) a protective cover that substantially encases the thumb assembly and the at least one finger assembly;

FIG. 5 is a palm view of the end effector of FIG. 4;

FIG. 6 is a side view of the end effector of FIG. 4;

FIG. 7 is a bottom view of the end effector of FIG. 4, shown without the covering;

FIG. 8 is a cross-sectional view taken along line 8-8 of the end effector of FIG. 7;

FIG. 9A is a cross-sectional view taken along line 9-9 of the end effector of FIG. 7;

FIG. 9B is a zoomed in view of the vision sensor in FIG. 9A;

FIG. 10 is partially exploded perspective view of the end effector of FIG. 7, showing components of the vision sensor;

FIG. 11 is an exploded view of the vision sensor of FIG. 10;

FIG. 12 illustrates the field of view of the vision sensor of one of the end effectors of the robot of FIG. 3B, where the vision sensor is positioned on the palm near the wrist and directed toward the thumb and finger assemblies;

FIG. 13 is a side view of the end effector of FIG. 7, showing line of sight for the vision sensor;

FIG. 14 is a front view of the end effector of FIG. 7, showing line of sight for the vision sensor;

FIG. 15 illustrates an image obtained by the end effector vision sensor of FIG. 12, showing the thumb and finger assemblies are within the field of view when in a first partially curled state;

FIG. 16 illustrates an image obtained by the end effector vision sensor of FIG. 12, showing the thumb and finger assemblies are within the field of view when in a second partially curled state;

FIG. 17 illustrates an image obtained by the end effector vision sensor of FIG. 12, showing the thumb and finger assemblies are within the field of view when in a third partially curled state; and

FIG. 18 is a side view of a portion of the left arm of the robot of FIGS. 1-3B, shown without coverings to illustrate alternative vision sensor positions and respective lines of sight directed toward the same focal point with respect to the thumb and finger assemblies.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is included in all embodiments and, in some embodiments, may not be included or may be combined with other features.

### A. Introduction

The disclosed end effector provides substantial benefits over conventional robotic systems, which often suffer from perceptual limitations during manipulation tasks. In an illustrative embodiment, a humanoid robot is disclosed comprising an arm assembly and an end effector coupled to a distal end of the arm assembly. Unlike conventional robots that rely on vision sensors located in the head or torso, the line of sight of which can be obscured by the robot's own body or objects in the environment, the disclosed end effector includes a vision sensor strategically positioned on its palmer side. This vision sensor is located between a distal portion of the arm and a knuckle assembly of the finger assembly, proximate to the wrist, providing a persistent, close-up, and unobstructed view of the grasping operation. This configuration eliminates common blind spots and enhances dexterity, enabling the sensor to detect critical information about contact between an object and the thumb or finger assemblies.

As determined while the humanoid robot is in an extended state, the vision sensor may be oriented at a downward-facing angle alpha ( ) of about 45 to 70 degrees with respect to a horizontal plane (PH) and at an inward-facing angle beta-prime ( ) of about 12 to 19 degrees with respect to a vertical plane (PV2). This specific orientation directs the line of sight toward the thumb and finger assemblies, ensuring they remain within the field of view during manipulation. The sensor assembly is an improvement over systems dependent on ambient lighting, as it includes an integrated illumination source, such as an LED light ring, that provides consistent, localized lighting for the field of view.

The information detected by the vision sensor is used by a control assembly to actively control the finger and thumb movements, creating a closed-loop feedback system. This visual feedback is supplemented by tactile sensors, such as strain gauges, positioned at the distal ends of the fingers and thumb. This fusion of visual and tactile data enables the robot to perform complex manipulations requiring delicate touch, a capability often lacking in conventional end effectors that rely on a single sensing modality. To protect these advanced components, a detachably removable protective cover, configured as a form-fitting glove, is positioned over the end effector. This cover is superior to conventional coverings as it is specifically designed with a sensor region that does not obstruct the vision sensor's field of view, ensuring protection does not compromise functionality. In alternative embodiments, additional vision sensors may be positioned on the lower arm or wrist, directed toward the same focal point to provide supplementary views of the end effector's operational space.

### B. Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head, torso, etc.) that generally resemble parts of a human. However, the robot does not need to include every part of a human (e.g., end effectors with over ten degrees of freedom), nor do its components need to have a shape that exactly or substantially resembles human parts. Furthermore, it should be understood that a humanoid robot is not designed to be primarily quadruped or have a wheeled base.

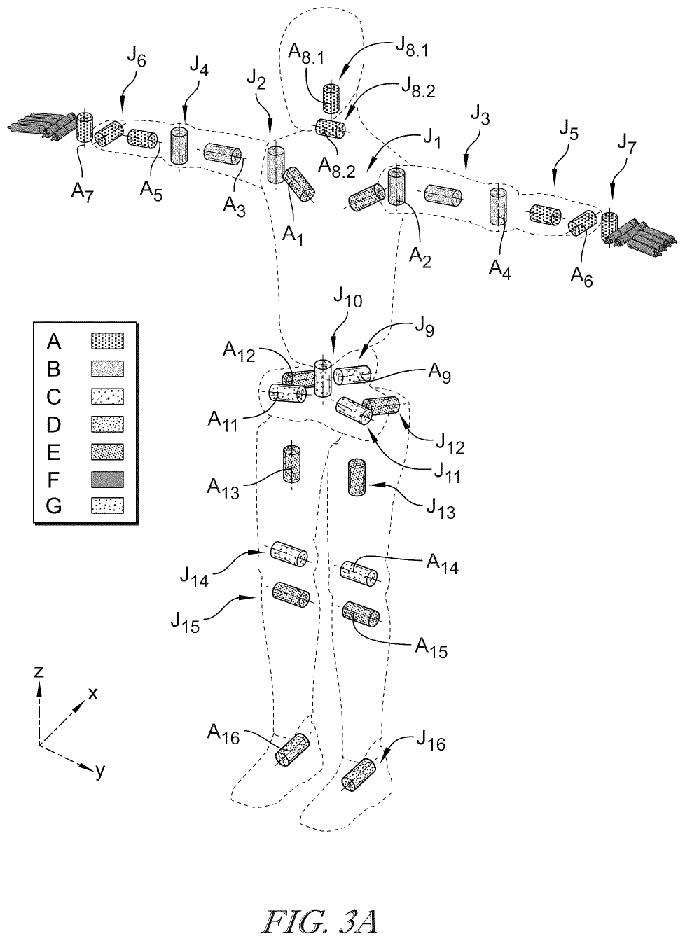

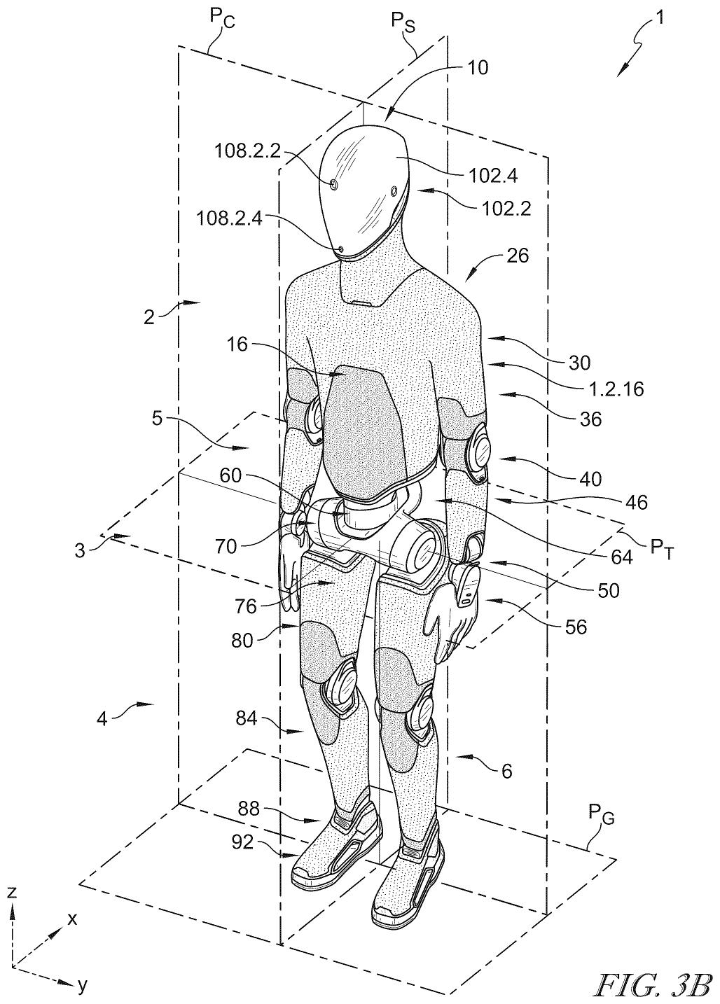

Neutral State: a state where the robot is standing upright on a horizontal support surface (P_{G}) and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the end effectors are oriented with the palms facing substantially inward, and the fingers pointing in a substantially downward direction toward the horizontal support surface. An illustrative example of the neutral state for the humanoid robot 1 is shown FIG. 3B.

Extended State: a state of the robot with the arms extended outward laterally at the shoulder (as illustrated in FIG. 3A) and oriented with the palms of the end effectors substantially facing downward and the fingers pointing in a substantially outward direction, where the central and lower portions of the robot remain in a neutral state.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (P_{S}) (e.g., as illustrated in FIG. 3A) is a vertical plane positioned at a midway point between the left and right legs and the left and right arms and contains a rotational axis A₁₀ of a torso twist actuator (J10) (e.g., as illustrated in FIG. 3B) located in the spine 60 of the robot 1 and divides the left and right sides of the robot 1 (e.g., as illustrated in FIG. 3A). In other words, in an illustrative embodiment, the sagittal plane (P_{S}) is a plane that is colinear with the rotational axis A₁₀ of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contains an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g., FIGS. 3A and 3B), the coronal plane (P_{C}) is a vertical plane that contains the rotational axes A₁₁ of the hip flex actuators (J11) located in the hips 70 (and likewise may contain an axis defined by a line connecting the midpoints of a left hip flex actuator (J11) axis (A₁₁) and a right hip flex actuator (J11) axis (A₁₁) and rotational axis A₁₀ of torso twist actuator (J10) located in the spine 60 of the robot 1. As shown in these figures, the coronal plane (P_{C}) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (P_{T}) is a horizontal plane that contains the mid-point of the rotational axes A₁₁ of the hip flex actuators (J11) located in the hips 70 of the robot 1.

Origin Point: an orthogonal intersection point of the sagittal plane, coronal plane, and transverse plane, all of which extend through the humanoid robot disclosed herein. In the illustrative embodiment of the robot 1 shown in FIG. 3A, an origin point (C_{P}) is present and shown.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 3A illustrates example Z, Y, X reference axes where the sagittal, coronal, and transverse planes share a common origin point.

Kinematic Chain: a representation of an assembly of rigid bodies connected by joints to provide constrained motion. Within this application, e.g., FIG. 3B, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position of the actuator with the limits expressed in Radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (Aₙ) of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane (Bₙ): a plane defined mid-width of actuator bearing between parallel edge guides and orthogonal to the rotational axis (Aₙ).

Textile: a flexible (e.g., fabric-like), highly durable cover material that has high elastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above.

### C. Robot(s) and Environment

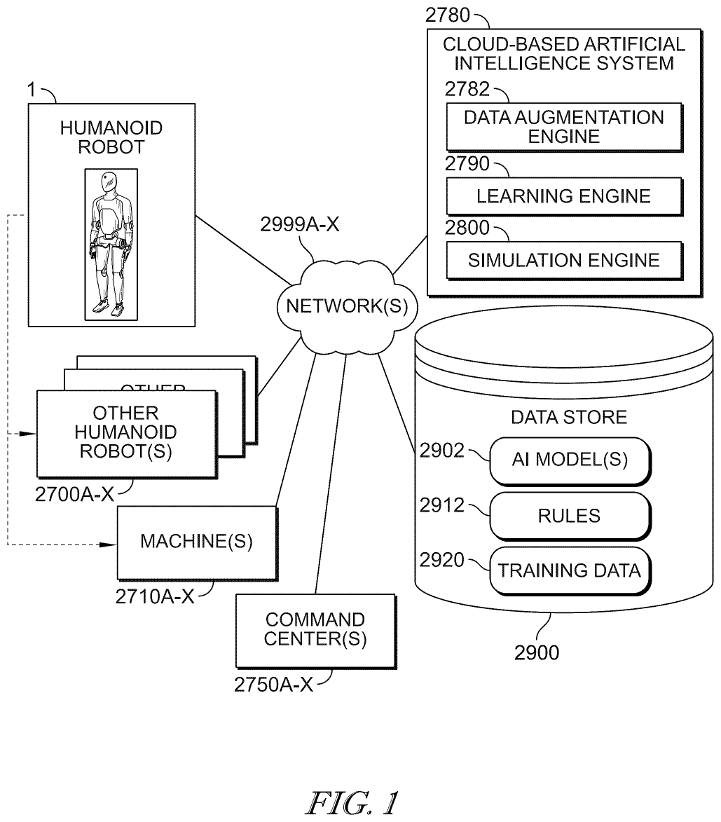

FIG. 1 illustrates an exemplary network and/or operational environment in which a humanoid robot (also referred to as a bipedal robot) 1, which is further detailed in additional figures herein, may operate. The environment may include a plurality of interconnected components, such as: (i) the humanoid robot 1, (ii) one or more other humanoid robots 2700A-X which may the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-base AI system, and (vi) one or more data stores 2900. Each component may be interconnected with another component, directly or indirectly, by at least one of: (i) one or more networks 2999A-X, (ii) direct communication systems (not illustrated—e.g., a data store 2900 may have direct communication with a remote AI system 2780) and/or (iii) physical contact with one another (e.g., the humanoid robot 1 may be in direct physical contact when operating a machine 2710A-X). The one or more networks 2999A-X may include, for example, the Internet, a local area network, a wide area network, a private network, a cloud computing network, or a network based on a wireless communication protocol. Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot 1 may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally and as such, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in the jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task.

The remote AI system 2780 may be comprised of one or more computing devices that are configured to perform global operations related to AI/ML for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot 1 to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) can be used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first person or third person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of vision data such as images and video frames (e.g., identifying anatomical point and/or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of AI/ML techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2790 to build, train, alter, fine-tune, or modify a previously generated model, a new model, and/or rules. Advantageously, the simulation engine 2800 is designed to improve efficiencies in the manufacture, testing, and deployment of a given humanoid robot 1 for a specified purpose.

The remote AI system 2780 may account for the substantial computing and resource demands of AI/ML-based techniques by processing at least a portion of data, requests, and/or training. As such, the humanoid robots 1 may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

Although FIG. 1 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800.

### D. Humanoid Robot

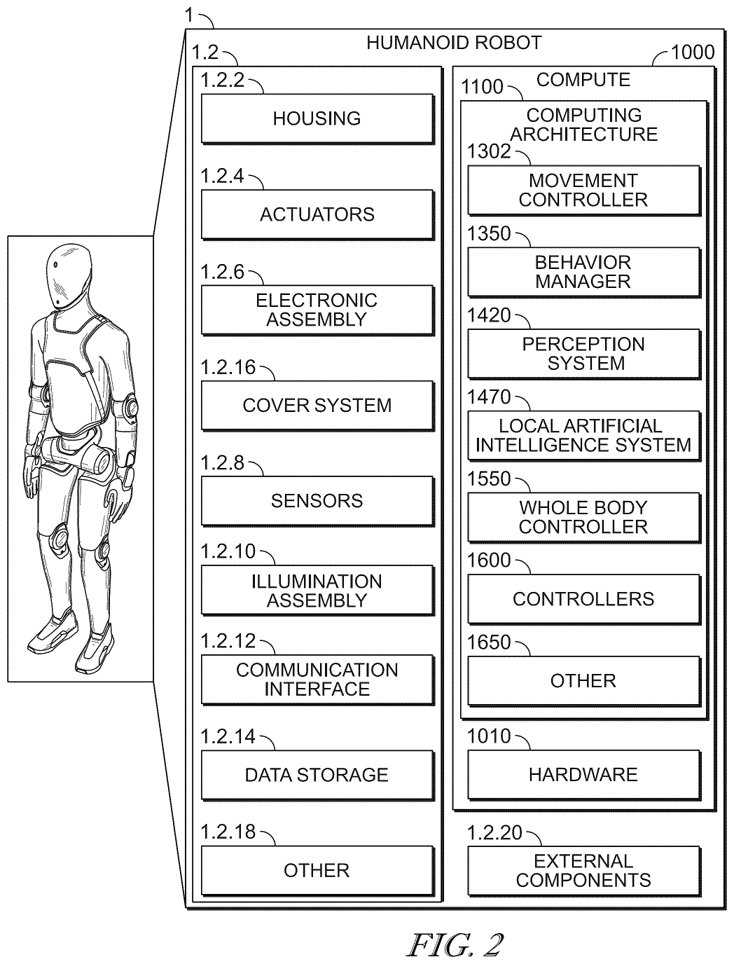

FIG. 2 is a block diagram of a humanoid robot 1 that includes a variety of architectures and other components that may include: (i) a mechanical/electrical architecture 1.2 that includes housings 1.2.2, actuators 1.2.4, electronic assembly 1.2.6, sensors 1.2.8, communication interface 1.2.12, illumination assembly 1.2.10, data storage 1.2.14, cover system 1.2.16, external components 1.2.20, other components 1.2.18, and (ii) compute 1000 that includes a computing architecture 1100 including instructions to be executed on computing hardware 1010 comprising at least one processor.

a. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are insufficient, and in some instances woefully insufficient, because they amount to mere design exercises that are not tethered to the complex realities of successfully creating a functional, general-purpose humanoid robot.

i. Robot Components

In addition to the general systems, assemblies, components, and parts described above, the humanoid robot 1 in the illustrative embodiment shown in FIG. 3A may include the following systems, assemblies, components, and parts, which can be broadly categorized into three regions. As shown in FIG. 3A, these three regions include: (i) an upper portion 2, which includes a head and neck assembly 10, a torso 16, left and right arm assemblies 5, and left and right end effectors 56 (also referred to as hands 56); (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6.

In the illustrative embodiment shown in FIG. 3A, each arm assembly 5 may include a shoulder 26, an upper humerus 30, a lower humerus 36, an upper forearm 40, a lower forearm 46, and a wrist 50. The end effector 56 is coupled to the wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92. In other embodiments, some of these systems, assemblies, components, or parts may be omitted, combined, or replaced with alternative designs.

### 1. Head and Neck Assembly

The head and neck assembly 10 of the humanoid robot 1 may be designed to enhance its anthropomorphic characteristics, while also providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as cheeks, eye protrusions, a mouth, or other moving parts, to maintain a non-humanlike appearance. The exterior surface of the head 10.1 is characterized by an absence of large flat surfaces (e.g., the head 10.1 is not a cube or prism) and the head is also not formed with significant cylindrical features or perfect circles. Instead, almost all exterior surfaces of the head 10.1 are curvilinear or contain substantial curvilinear aspects, which presents a generally egg-shaped appearance when viewed from the front or top.

Structurally, the head 10.1 is symmetrical about the sagittal plane P_{S} but is asymmetrical about Z-Y and X-Y planes that intersect the head and are parallel to the coronal plane (P_{C}) and the transverse plane (P_{T}), respectively. The width (parallel to the y-axis) and depth (parallel to the x-axis) of the head 10.1 change constantly from top to bottom, reaching a maximum dimension in the temple region, which is located at approximately 30-50% of the head's height from its top end.

The head 10.1 itself may house a range of components, such as high-resolution cameras, microphones, and displays, all of which are contained within an impact-resistant polymer shell 102.2. This shell 102.2 includes a large, freeform (i.e., not conforming to a regular or formal structure or shape) frontal shield 102.4 that covers the frontal and crown regions of the head 10.1. The frontal shield 102.4 is formed as a separate and distinct piece from the displays positioned behind it, thereby protecting the displays and internal electronics from damage. This separation provides a significant advantage during the performance of industrial tasks, as a damaged frontal shield 102.4 is substantially cheaper and easier to replace than a damaged display. The frontal shield 102.4 extends rearward beyond an auricular region into an occipital region and extends down to a chin region, but it does not extend below a jaw line.

Cameras embedded within the head 10.1 may include RGB, depth-sensing, thermal imaging capabilities and/or any other cameras disclosed herein, which are designed to enable the humanoid robot 1 to perform tasks such as object recognition, environmental mapping, and facial expression analysis. For the specific purpose of generating a low-latency Virtual Reality (VR) view, a pair of high-resolution, high-frame-rate RGB cameras with global shutters may be utilized. For example, this pair of cameras may be the vertically arranged cameras 108.2.2 and 108.2.4, or they may be horizontally arranged internal/external cameras. Microphones may be arranged in an array to facilitate directional audio input and noise cancellation, which enhances the ability of the humanoid robot 1 to understand and respond to verbal commands.

Displays integrated into the head 10.1 may serve as user interfaces, providing visual feedback or conveying expressions to improve communication and user engagement. Unlike the heads of conventional robots, the disclosed head 10.1 includes a main display 108.4 that is curved in at least one direction and is positioned at an angle relative to a sagittal plane. This curved design permits the inclusion of a larger display with a greater surface area compared to a flat screen, which increases the amount of information that can be conveyed, such as robot status and sensor data. This information is displayed using generic blocks or shapes rather than anthropomorphic features like eyes or a mouth. In addition to the main display 108.4, two side-facing displays are included to show indicia such as the identification number/serial number, battery life, current task, any safety indicia, and/or any other information associated with the humanoid robot 1.

Further, an extent of the illumination assembly 1.2.10, which comprises a plurality of light emitters, is positioned adjacent to an edge (e.g., lower) of the frontal shield 102.4. These light emitters may be configured to function as indicator lights to communicate the status of the robot 1 to nearby humans—for instance, by emitting light that appears to humans in different colors (e.g., yellow for working, green for idle, red for an error state, or blue for thinking) or illumination sequences-without relying on the main displays. This method of communication may be more power-efficient than displays, and may relay information more rapidly.

Additionally, the head 10.1 may house: (i) other sensors, such as gyroscopes and accelerometers, (ii) heat management systems (e.g., heat pipes, fans, etc.), (iii) wireless communication modules (e.g., 5G cellular, Wi-Fi, Bluetooth) and antennas. To maximize bandwidth and ensure connectivity, a plurality of 5G cellular radios may be positioned in the torso 16 and wired through the neck to the antennas in the head 10.1. The head and neck assembly 10 may also incorporate advanced materials and shock-absorbing structures to protect the sensitive electronic components housed within, which may improve the overall durability and reliability of the humanoid robot 1.

The head and neck assembly 10 may include two primary actuators: a head twist actuator (J8.1) 120, which is responsible for enabling rotational movement of the head 10.1 about axis A_{8.1}, which is a vertical (yaw) axis when the robot is in the neutral state, and a head nod actuator (J8.2) 140, which enables rotation of the head 10.1 about the axis A_{8.2}, which is a horizontal axis when the robot is in the neutral state. Together, these two actuators may provide two degrees of freedom for the head 10.1, allowing it to perform movements that emulate natural human head motions. The head twist actuator (J8.1) 120 may be positioned within the head and neck assembly 10, while the head nod actuator (J8.2) 140 may be located at the base of the neck. This head twist actuator (J8.1) 120 and head nod actuator (J8.2) 140 may each utilize a motor, a gear reduction system, and sensors or encoders that are similar to the actuator types discussed herein.

The head actuators, J8.1 and J8.2, may work in coordination to position the head 10.1 accurately, enabling the humanoid robot 1 to track objects, focus on specific areas of interest, or maintain eye contact during human-robot interactions. The actuators may be controlled, in conjunction with input from vision and inertial sensors, to execute smooth, human-like movements. For example, the head twist actuator (J8.1) 120 may rotate the head 10.1 to follow a moving object, while the head nod actuator (J8.2) 140 adjusts the pitch to maintain an optimal viewing angle.

Variations of this design may include the addition of a third actuator to provide roll motion, which would further increase the range of movement of the head 10.1 to three degrees of freedom (3-DoF) and could enable more expressive head gestures, such as tilting the head sideways to convey curiosity or empathy. Alternatively, for specialized applications, the actuators (J8.1) and/or (J8.2) may be replaced with compact linear actuators or parallel-link mechanisms.

Additionally, variations of head 10.1 may include modular head designs that allow for the quick customization or replacement of sensory and communication components. These modular designs may facilitate easy upgrades or modifications to the capabilities of the humanoid robot 1 without extensive changes to the overall head and neck assembly 10. Furthermore, advanced control algorithms may be implemented to enable more natural, biomimetic head movements, potentially incorporating machine learning techniques to adapt and refine the motion patterns of the head 10.1 based on interaction data and environmental feedback.

### 2. Torso

The torso assembly 16 is a central component within the humanoid robot 1, extending vertically between the waist and the head and neck assembly 10, and horizontally between the shoulders 26. The torso 16 is designed to provide the robot 1 with a generally humanoid shape, offer structural and operable support for the arm assemblies 5 and the head and neck assembly 10, and house and protect internal components, including the arm actuators (J1) 190 and an electronics assembly 1.2.6 housed at least partially within the torso 16.

The electronics assembly 1.2.6 contained primarily within the torso 16 includes various interconnected components that are essential for the operation of the robot 1, including the battery pack, the compute 1000 (which includes CPUs and GPUs), power distribution unit, and a charging system. The components are strategically positioned to optimize space and balance. The battery pack may be rearwardly offset, positioned in a rear section of the torso 16, while the compute 1000 is placed in a forward section. This spatial distribution helps to maintain a balanced posture, allows for efficient cooling, and maximizes the size and power density of the battery pack. A cooling system may be integrated between the battery pack and the compute 1000 to manage their respective thermal loads. The electronics assembly 1.2.6 may be designed with modularity to facilitate easier maintenance, repair, and upgrades. The charging system may support both wired and wireless protocols. A wired system might use a docking station, while a wireless system could utilize inductive charging, with coils that may be embedded in a housing 1.2.2 and/or the feet 92. The charging system may also include safety features such as overcharge protection and temperature monitoring.

The torso 16 may have a total volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack that exceeds 2 liters, preferably more than 4 liters, and most preferably more than 6 liters in capacity. Consequently, the humanoid robot 1 may incorporate a battery pack with a capacity exceeding 2.5 kWh, which may provide an operational runtime of over 3.5 hours under normal conditions, and preferably more than 4.5 hours, and most preferably more than 6 hours. In some implementations, the torso 16 may adopt a quasi-trapezoidal prism configuration, wherein its front surface is smaller than its back surface, with angled side shrouds connecting these two sections. This geometric design may enhance the range of motion of the robot 1, particularly by improving its ability to reach across its own body.

### 3. Arm Assemblies

The arm assemblies 5 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the end effector to the lower forearm. Furthermore, the wrist 50 may include a quick-release mechanism that enables the interchange of different end-effectors or tools. Moreover, the housing of each component may be designed with internal reinforcement structures, may be made from various materials (e.g., metal alloys or advanced materials like carbon-fiber-reinforced polymers).

### 4. End Effector

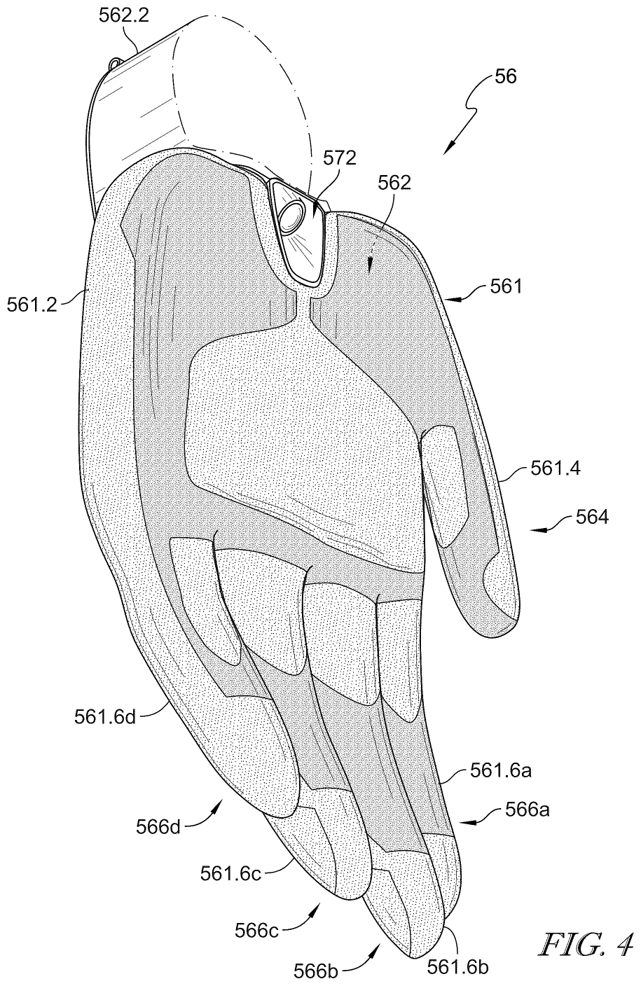

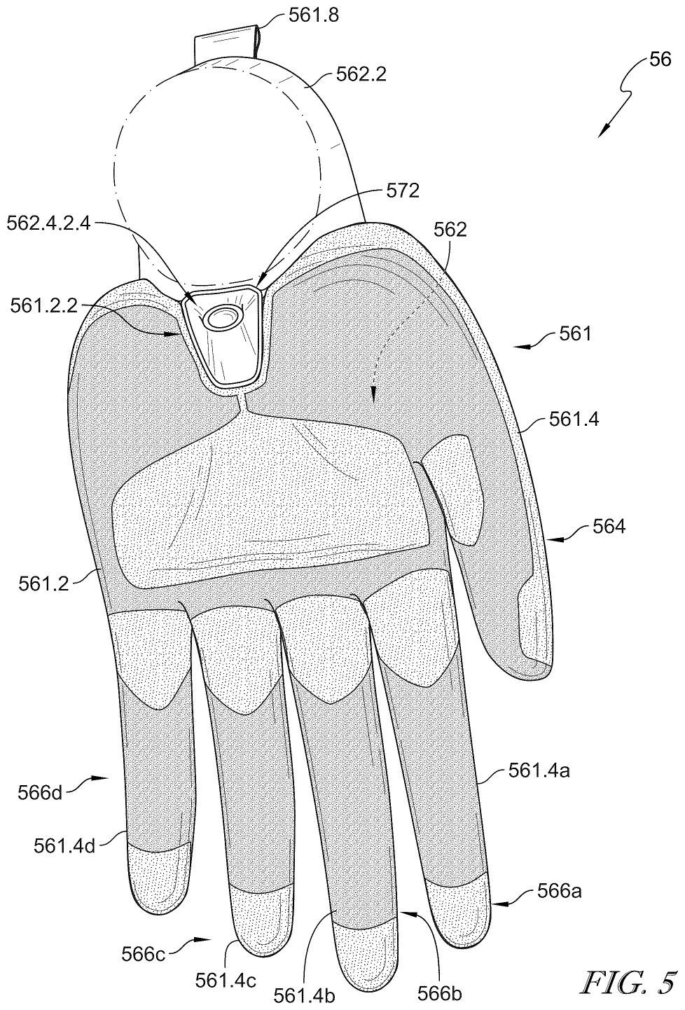

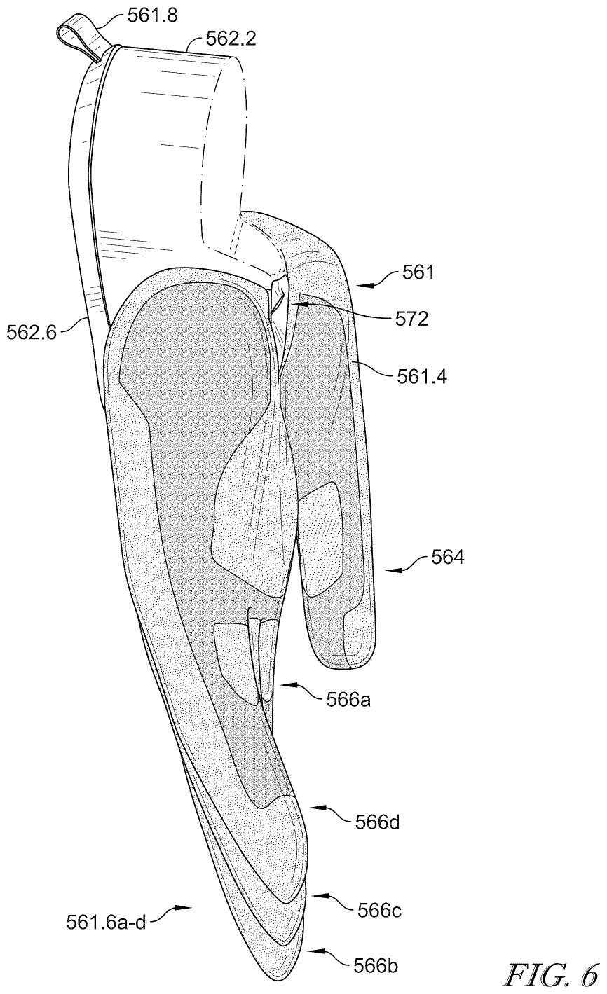

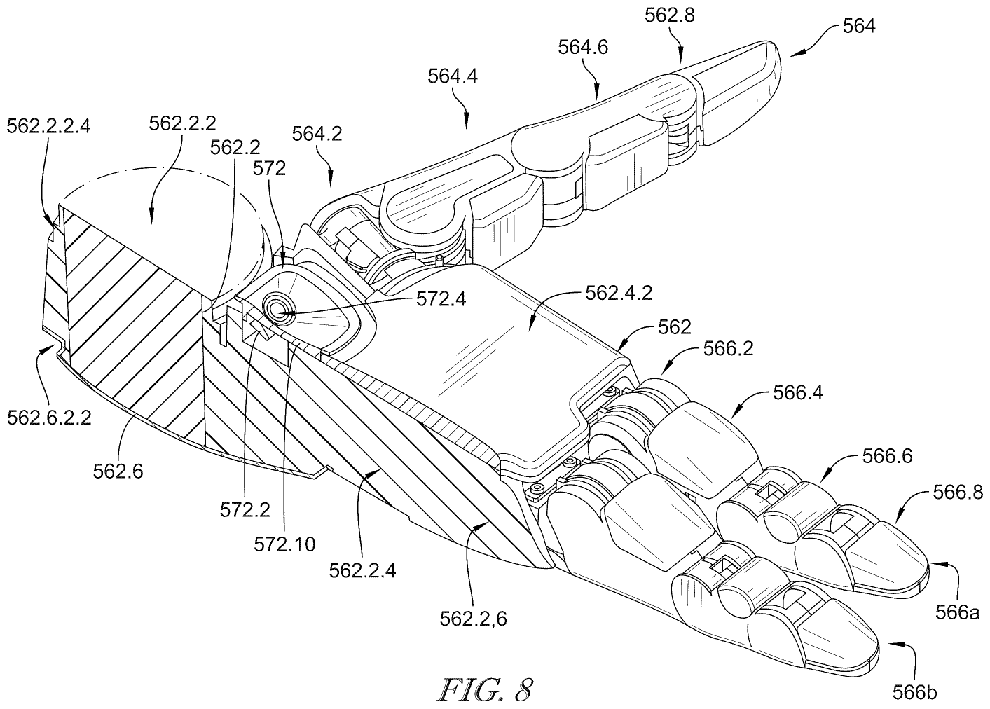

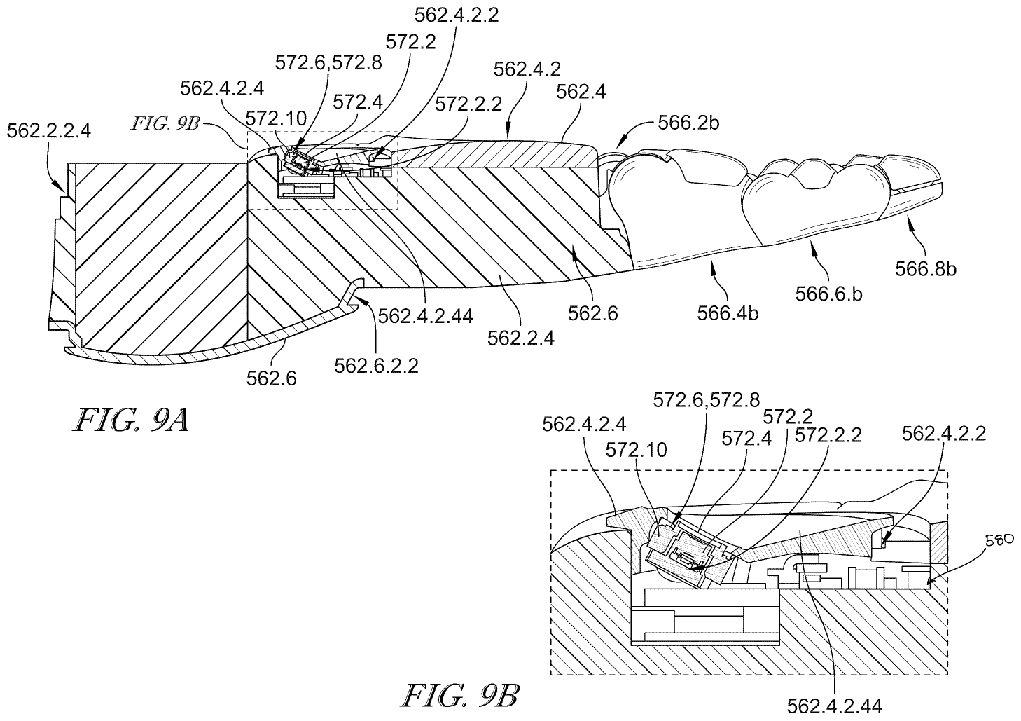

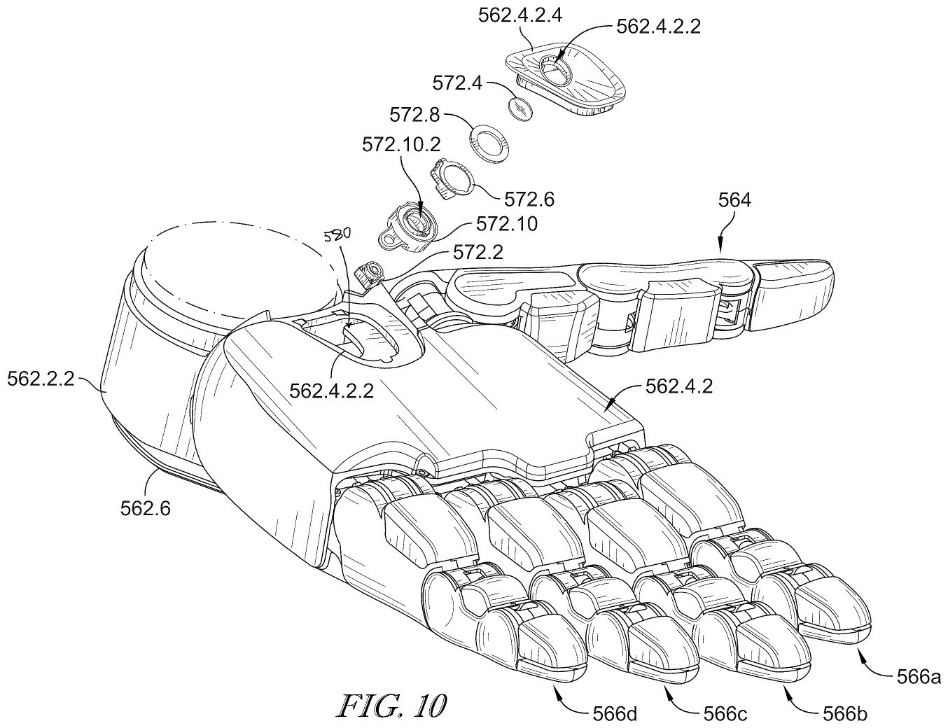

As shown in FIGS. 4-14, each end effector 56 of the robot 1 includes: (i) an end effector housing 562, (ii) at least one finger assembly 566 (e.g., finger assemblies 566a-566d), (iii) a thumb assembly 564, (iv) an electronics assembly 580 contained within and/or coupled to the end effector housing 562, and (v) a protective cover 561 (also referred to as a hand cover or a glove). The end effector 56 has a palmer side and an opposite dorsal side. The at least one finger assembly 566 and the thumb assembly 564 are coupled to the end effector housing 562. The electronics assembly 580 may include a control assembly, tactile sensor assemblies 568, and a vision sensor 572, where the control assembly is configured to at least control the motor assemblies of said at least one finger assembly 566 and said thumb assembly 564. The protective cover 561 is arranged to cover and protect a substantial portion the end effector housing 562, the thumb assembly 564, and the finger assemblies 566a-d.

The vision sensor 572 is positioned to obtain information about the contact between an object and an extent of either the thumb assembly 564 or first finger assembly 566a. The vision sensor 572 of the end effector 56 may be positioned on the palmer side between (i) a distal portion of the arm 5 and the knuckle assembly 566.2 of the at least one finger assembly 566 and (ii) proximate to the wrist 50. The vision sensor 572 may be positioned towards the distal assembly of the wrist 50, preferably forward of the entire wrist 50. The vision sensor 572 may be a component of the vision system of the robot 1. In various embodiments, an imager, imaging detector, or camera of the vision sensor 572 may be the same as or substantially similar to the vision sensors contained in the head 10.1 of the robot 1. For example, the vision sensor 572 may comprise a first imaging detector, and the head 10.1 may include a second imaging detector that is identical to the first imaging detector.

a. End Effector Housing

The end effector housing 562 may include: (i) a coupling frame 562.2, (ii) a main enclosure 562.4, and (iii) at least one actuator cover 562.6. The end effector housing 562 is designed to: (i) connect the end effector 56 to the arm assembly 5, (ii) secure the finger assemblies 566a-566d in at least one plane, (iii) secure the thumb assembly 564, and (iv) encase and protect at least the control assembly of the electronics assembly 580. Additionally, a heat sink may be positioned at the dorsal side of the end effector, for example, on a dorsal surface 562.4.4 of the main enclosure 562.4, to facilitate thermal management. The thumb assembly 564 and finger assemblies 566a-566d are coupled to the coupling frame 562.2 and the main enclosure 562.4 surrounds a portion of the coupling frame 562.2 including components coupled thereto. The thumb assembly 564 and finger assemblies 566a-566d are configured to move relative to a palm surface 562.4.2 of said main enclosure 562.4.

The coupling frame 562.2 includes: (i) a wrist coupling portion 562.2.2, (ii) a palm portion 562.2.4, (iii) a finger coupling portion, and (iv) a thumb coupling portion. The wrist coupling portion 562.2.2 includes an actuator receptacle 562.2.2.2 within a coupling wall 562.2.2.4. The end effector 56 is coupled to the wrist 50 of the arm assembly 5 of the robot 1. In particular, the wrist pivot actuator (J7) is received within the actuator receptacle 562.2.2.2. The actuator receptacle 562.2.2.2 is configured to be covered by the actuator cover 562.6 that extends over an extent of the palm portion. The actuator cover 562.6 may form a wrist actuator housing and may include an exterior rim portion 562.6.2 that includes an attachment channel 562.6.2.2 that partially encircles the actuator receptacle 562.2.2.2. In various embodiments, the actuator cover 562.6 may include heat transfer features. The palm portion 562.2.4 includes a proximal palm portion adjacent to the coupling wall 562.2.2.4, a distal palm portion configured to couple with the at least one finger assembly 566, an interior palm portion from which the thumb assembly 564 extends, and an exterior palm portion. The control assembly is coupled to the palm portion 562.2.4 and the tactile sensor assemblies 568, and the vision sensor 572 of the electronics assembly 580 are communicatively coupled to the control assembly.

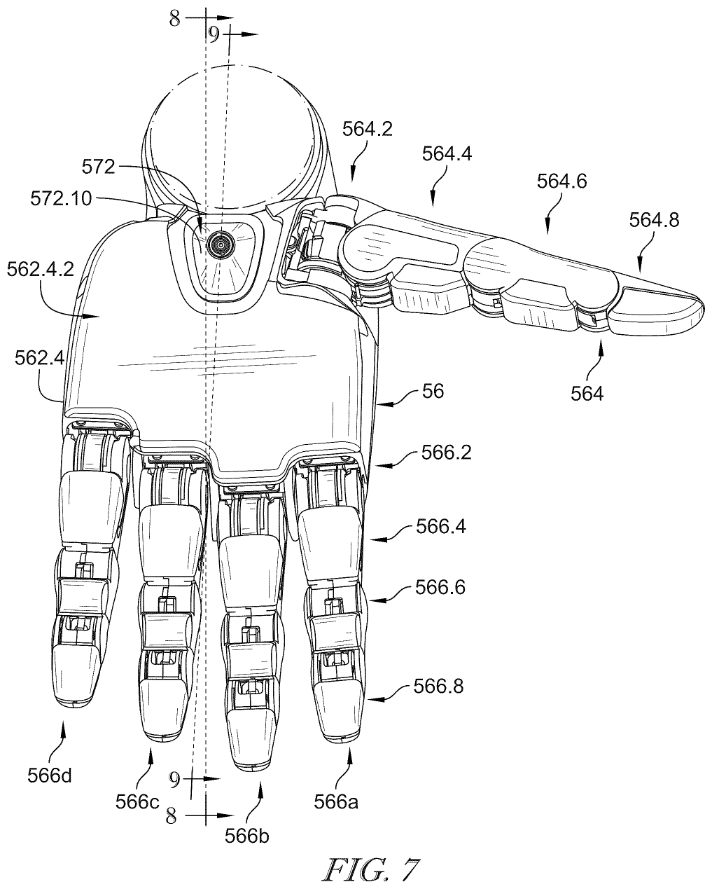

The palm portion 562.2.4 of the end effector housing 562 is substantially enclosed by the main enclosure 562.4. The main enclosure 562.4 may comprise a palm surface 562.4.2 and an opposite dorsal surface 562.4.4 (also referred to as back of hand surface). The main enclosure 562.4 may be formed from one or more pieces. In various embodiments, the end effector housing 562 is configured to include one or more openings for at least one sensor (e.g., vision sensor 572) of the electronics assembly 580. In the illustrative embodiment, the end effector 56 includes the vision sensor 572 coupled to the palm portion 562.2.4 of the coupling frame 562.2 and a sensor opening 562.4.2.2 is formed in the palm surface 562.4.2 of the end effector housing 562 within a proximal portion near the coupling wall 562.2.2.4. As shown in FIGS. 7-10, the main enclosure 562.4 may include a sensor mounting frame 562.4.2.4 coupled to or formed in the palm surface 562.4.2 at the sensor opening 562.4.2.2. In other embodiments, the sensor opening 562.4.2.2 may be located on another area of the end effector housing 562. Alternatively, the sensors may be mounted to the exterior of the end effector housing 562, and as such the opening for the at least one sensor may be omitted. In other embodiments, the end effector may completely omit sensors that require an opening to receive information.

The end effector housing 562 may be made from silicon, ABS plastic, polycarbonate, carbon fiber composite, aluminum alloy, stainless steel, polyurethane, nylon, polyvinyl chloride (PVC) plastic, polypropylene, acetal, polyimide, polytetrafluoroethylene (PTFE), magnesium alloy, foam polymer, high impact polystyrene, graphene composite, Kevlar, deformable silicon, polyethylene, thermoplastic elastomer, polyoxymethylene (POM), a combination of these materials, and/or any other known material used in robot systems. In some embodiments, the main enclosure 562.4 of the end effector 56 may be less rigid or softer than the coupling frame 562.2 of the end effector housing 562. For example, the main enclosure 562.4 of the end effector 56 may be made from a deformable silicon material, while the internal frame (e.g., coupling frame) of the housing may be made from metal. It should be understood that these are examples of possible configurations and are not intended to be limiting in any manner. In some embodiments, the energy attenuation members of the cover system 1.2.16 may be coupled directly to the end effector housing 562, under the protective cover 561.

b. Thumb and Finger Assemblies

Referring to FIG. 7, the illustrative embodiment of end effector 56 includes four finger assemblies 566a-566d and a thumb assembly 564 coupled to the coupling frame 562.2. Individually, each of the finger assemblies 566 have the same configuration and same length, allowing for interchangeability of the finger assemblies 566 and a reduction of parts. The assemblies 566 are coupled to the coupling frame 562.2 at the finger coupling portion at the distal end of said frame. The finger assemblies 566a-566d may be arranged in the same direction, extending outward in a plane parallel to the arm axis (A_{L}) of the robot 1. The individual finger assemblies 566a-566d may be offset distally, where the individual finger axes may be in the same plane, when in an uncurled state. The thumb assembly 564 is coupled to the coupling frame 562.2 at the proximal palm portion at the thumb coupling portion and directed outward. In the illustrative embodiment, the thumb assembly 564 and finger assemblies 566a-566d include motor assemblies with six actuators providing 16 degrees of freedom (DoF). In particular, the six actuators are positioned within the housing 562 of the end effector 56 to provide at least three DoF for the thumb 564 and as least two DoF for each of the finger assemblies 566a-d. Although the example shows only one of the end effectors 56 (e.g., left end effector) in the illustrative embodiment, the disclosure applies equally for the other end effector 56, which may include components a mirrored configuration about the sagittal plane (P_{S}) of the robot 1.

The thumb assembly 564 and each of the finger assemblies 566a-566d contained in the end effector 56 includes (i) a motor assembly, (ii) a knuckle assembly 564.2, 566.2, (iii) a proximal assembly 564.4, 566.4, (iv) a medial assembly 564.6, 566.6, and (v) a distal assembly 564.8, 566.8. The knuckle assembly 564.2, 566.2 is positioned forward of a majority of the motor assembly and is configured to allow the thumb assembly 564 or the finger assembly 566a-566d to move from the open, uncurled, or neutral state to the fully curled state. The proximal assembly 564.4, 566.4 is positioned between the knuckle assembly 564.2, 566.2 and the medial assembly 564.6, 566.6 and is the first portion of the thumb assembly 564 or the finger assembly 566a-566d configured to move relative to the palm surface 562.4.2 of the end effector housing 562. The medial assembly 564.6, 566.6 is positioned between the proximal assembly 564.4, 566.4 and the distal assembly 564.8, 566.8 and is the second portion of the thumb assembly 564 or the finger assembly 566a-566d configured to move relative to the palm 562.4.2. The distal assembly 564.8, 566.8 is positioned forward of the medial assembly 564.6, 566.6 and is the third portion of the thumb assembly 564 or the finger assembly 566a-566d configured to move relative to the palm surface 562.4.2.

The motor assemblies are configured to actuate movement of the thumb assembly 564 and the at least one finger assembly 566. For example, the thumb assembly 564 and finger assemblies 566a-566d may move individually or in some combination between an open, uncurled, or neutral state, a partially curled state, and a fully curled state. The motor assemblies are responsible for driving various degrees of freedom within the end effector 56, enabling precise and dynamic control of the robotic hand's movements. The motor assemblies are designed to be releasably coupled to the coupling frame 562.2. This modular design allows for ease of maintenance, replacement, and customization of the motor assembly based on specific application requirements. The thumb motor assembly may be different from the finger motor assembly. For example, the thumb motor assembly may include a first motor and a second motor, whereas the individual finger motor assemblies may include only a first motor. These motors can be selected from a variety of types, including but not limited to: slotless brushless direct current (BLDC) motors, brushed DC motors, stepper motors, switched reluctance motors, permanent magnet synchronous motors, and servo motors. Each type of motor offers distinct advantages based on application needs, such as high torque output, precise positioning, or energy efficiency. It should be noted that the first motor and the second motor may either be identical in type and specifications or differ based on the specific functional requirements of the end effector 56. In an example where the motors are different, the first motor controlling flexion/extension could be a high-torque brushless DC motor, while the second motor for abduction/adduction could be a stepper motor for precise positioning. Variations between the motors can include, but are not limited to, different torque outputs, transmission ratios, gear types, end stop configurations, or other operational characteristics.

c. Electronics Assembly

Referring to FIGS. 7-10, the electronics assembly 580 contained in the end effector 56 may include: (i) one or more vision sensors 572, (ii) tactile finger sensor assemblies 568, and (iii) a control assembly and/or other electronics for controlling the end effector 56. The vision sensor 572 may be housed in the main enclosure 562.4 of the end effector housing 562 and the finger sensor assemblies 568 are housed in the thumb and finger assemblies 564, 566a-566d. In the illustrative embodiment, the vision sensor 572 includes an illumination source 572.6 configured to illuminate a field of view of the vision sensor 572. In various embodiments, the electronics assembly 580 may also include a light emitter as a component of the illumination assembly 1.2.10 and/or configured to illuminate a field of view of the vision sensor 572. Said light emitter may be coupled to the vision sensor 572, the end effector housing 562, or another housing of the arm assembly 5 that may be directed toward the end effector 56. Further, the electronics assembly 580 contained in the end effector 56 may include one or more temperature, pressure, force, inductive, capacitive, any combination of these sensors, or other known sensors.

The control assembly is configured to control at least the motor assemblies, of said thumb assembly 564 and at least one finger assembly 566. The control assembly is also coupled to the tactile sensor assemblies 568, the vision sensor 572, and the light emitter 574, each of which may be in communication with or be controlled by the control assembly. Information about contact detected by the vision sensor 572 may be used, at least in part, by the control assembly to control movement of the first finger assembly 566a and movement of the thumb assembly 564. Further, the electronics assembly 580, for example via the control assembly, may be communicatively coupled to computing architecture 1100 of the robot 1 including: (i) a movement controller 1302, (ii) a behavior manager 1350, (iii) a perception system 1420, (iv) a local AI system 1470, (v) a whole body controller 1550, (vi) one or more controllers 1600, and (vii) other subcomponents 1650.

i. Vision Sensor

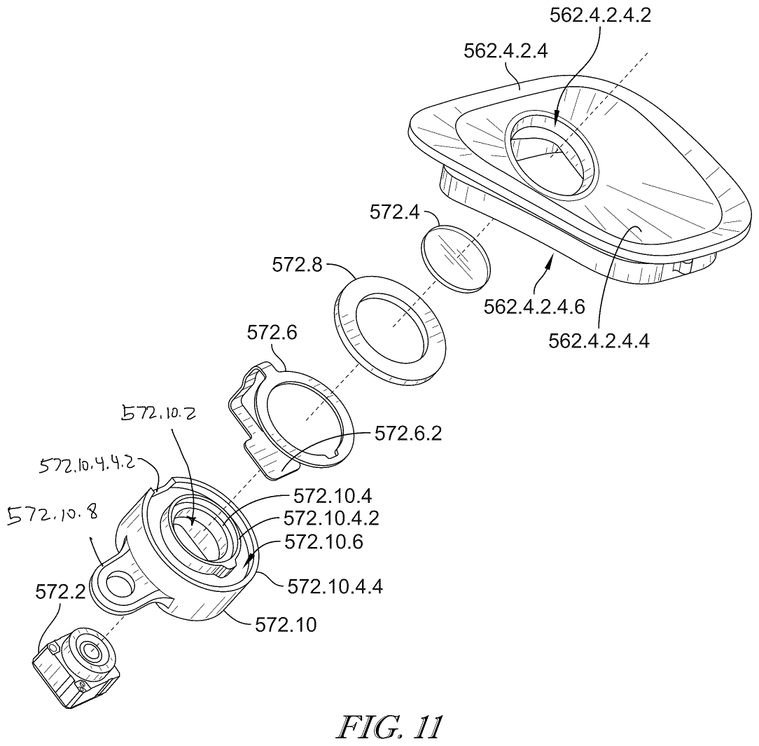

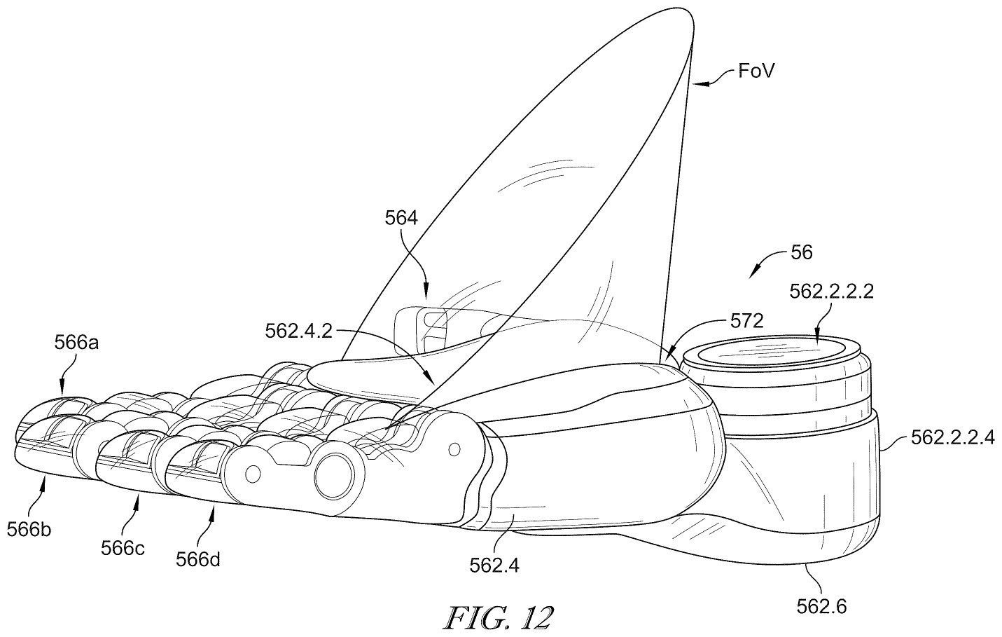

Referring to FIGS. 11-12, the vision sensor 572 includes an imager 572.2 (e.g., camera), a lens 572.4, an illumination source 572.6 (e.g., a LED light ring), a lighting cover 572.8, and a sensor housing 572.10. The imager 572.2 may also include an imaging detector. The lens 572.4 overlies and protects the imager 572.2 and the imaging detector. The illumination source 572.6 is positioned near the image detector 572.2. The vision sensor 572 may be positioned between a distal portion of the arm 5 and the knuckle assembly 566.2 of the finger assembly 566 (e.g., finger assemblies 566a-d). In the illustrative embodiment, the vision sensor 572 is configured to couple to a sensor mounting frame 562.4.2.4 of the main enclosure 562.4. In the illustrative embodiment, the sensor housing 572.10 may include a center aperture 572.10.2, a rim 572.10.4 surrounding the center aperture 572.10.2, an inner wall 572.10.4.2 and an outer wall 572.10.4.4 projecting outward from the rim 572.10.4 forming a channel 572.10.6, and at least one mounting feature 572.10.8 configured to couple the sensor housing 572.10 to the sensor mounting frame 562.4.2.4 and/or the main enclosure 562.4. The sensor housing 572.10 is configured to receive and hold the imager 572.2 and the lens 572.4, where the line of sight of the imager 572.2 directed outward through the lens 572.4 coupled to the center aperture 572.10.2. In some embodiments, the lens 572.4 may be omitted. In the illustrative embodiment, the illumination source 572.6 is a LED light ring configured to be received within the channel 572.10.6 formed in the rim 572.10.4 in a plane perpendicular to the line of sight of the imager 572.2. The illumination source 572.6 may include a lead 572.6.2 electrically connected to the control assembly. In some embodiments, the sensor housing 572.10 may include a notch 572.10.4.4.2 in the outer wall 572.10.4.4 to extend the lead 572.6.2 on the exterior of the sensor housing 572.10 within the sensor mounting frame 562.4.2.4. A translucent lighting cover 572.8 may also be received into the channel 572.10.6 to protect the illumination source 572.6 and diffuse the emitted light. In various embodiments, the lighting cover 572.8 may be an encasement material (e.g., potting) applied within the channel 572.10.6 to secure the illumination source 572.6. In alternative embodiments, the illumination source 572.6 may include a dot projector (e.g., infrared projector) to aid in distance determinations.

The vision sensor 572 may be positioned within and coupled to the sensor mounting frame 562.4.2.4 of the main enclosure 562.4. The sensor mounting frame 562.4.2.4 includes an opening 562.4.2.4.2, a contoured surface 562.4.2.4.4, and a receiving frame 562.4.2.4.6 mounted to a surface opposite the contoured surface 562.4.2.4.4. The vision sensor 572 is arranged within the receiving frame 562.4.2.4.6 and the sensor housing 572.10 coupled to the sensor mounting frame 562.4.2.4, where the imager 572.2 is substantially centered on the opening 562.4.2.4.2 to direct the line of sight of said imager 572.2. The line of sight: (i) extends through the center of the lens 572.4, (ii) is co-linear with the center axis of the vision sensor 572, and/or (iii) is centered and perpendicular to the image plane, sensor array, and/or image sensor 572.2.2 of the imager 572.2. As best shown in FIG. 12, the contoured surface 562.4.2.4.4 is shaped to provide an unobstructed field of view of the palm surface 562.4.2 and at least a portion of the thumb and finger assemblies 564, 566a-566d which may be actuated to curl toward the palm surface 562.4.2. The vision sensor 572 is positioned such that a majority of the palm side of the end effector 56 is in the field of view of the vision sensor 572. In the illustrative embodiment, the sensor mounting frame 562.4.2.4 may be a separate component that couples to the sensor opening 562.4.2.2 of the main enclosure 562.4. In other embodiments, the sensor mounting frame 562.4.2.4 may be formed with the main enclosure 562.4.

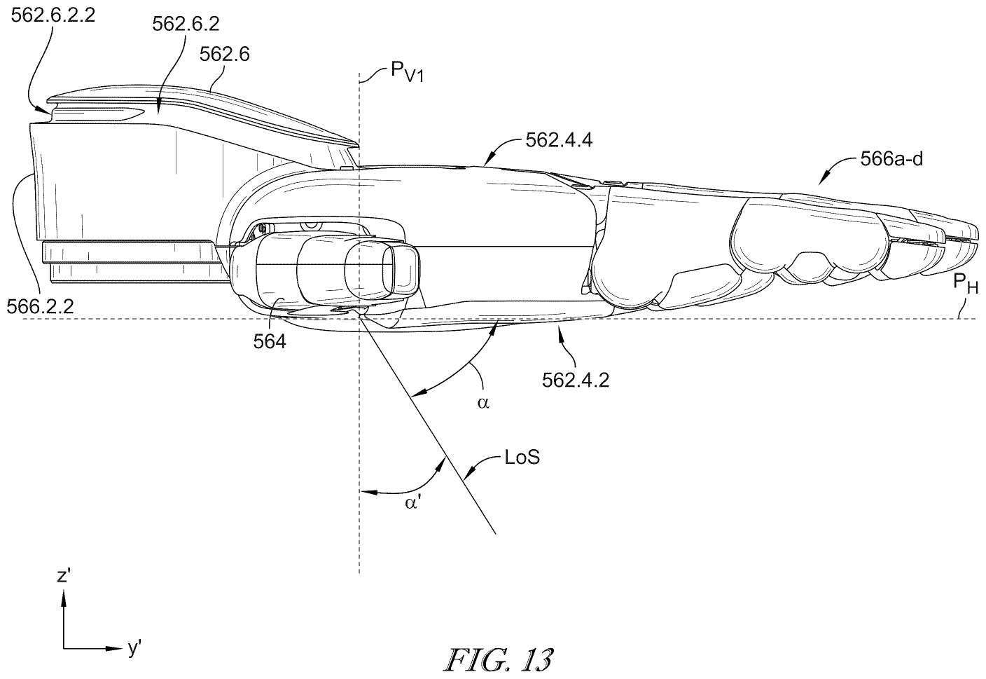

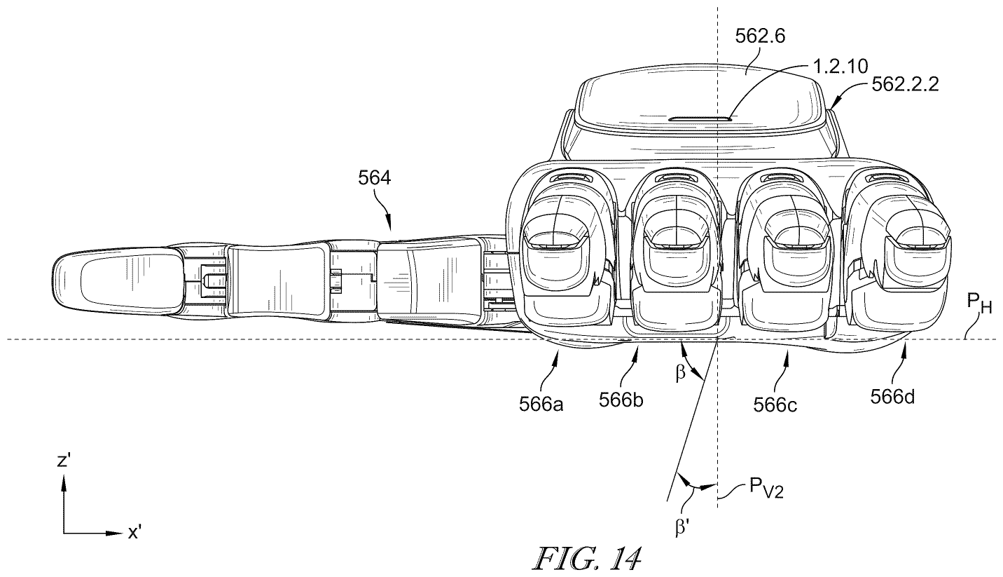

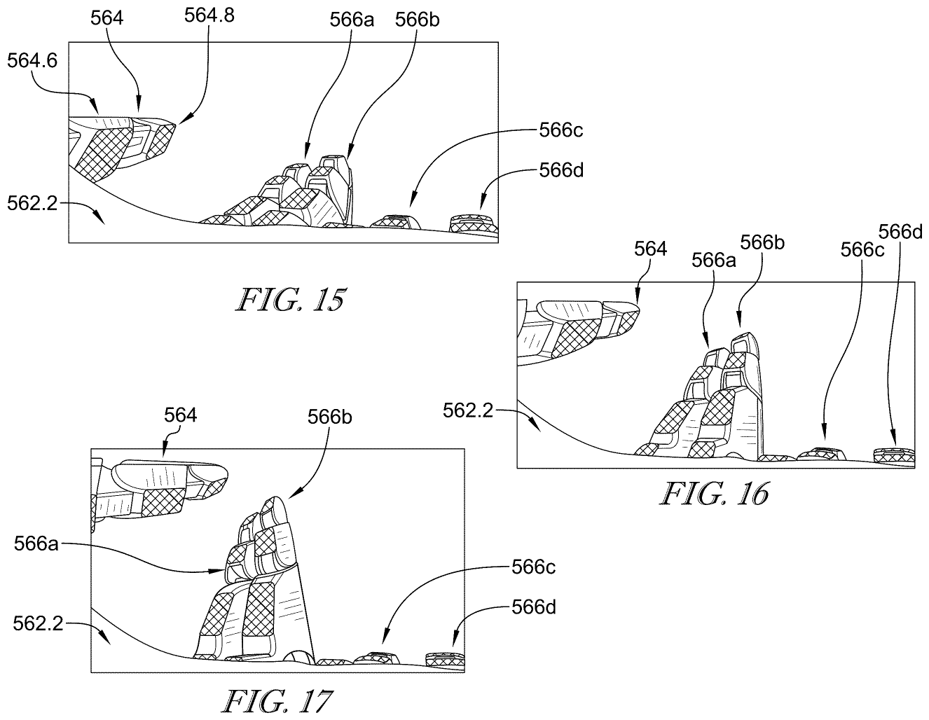

In the illustrative embodiment, the vision sensor 572 is coupled to the end effector on the palmer side and positioned at a sensor opening 562.4.2.2 on the palm surface 562.4.2 near the coupling wall 562.2.2.4. The vision sensor is thereby oriented so that the line of sight is directed toward the thumb and finger assemblies 564, 566a-566d, such that the thumb and finger assemblies 564, 566a-566d are in the field of view of the vision sensor 572. For reference, coordinate axis (x′, y′, z′) of the end effector 56 may be defined with respect to the robot 1 in an extended position with the arms 5 extended outward at the side and palms (e.g., palm surface 562.4.2) facing downward. As such, a first vertical plane (P_{V1}) may be an x′-z′ plane parallel to the sagittal plane (P_{S}), a second vertical plane (P_{V2}) may be a y′-z′ plane parallel to the coronal plane (P_{C}), and a horizontal plane (P_{H}) may be an x′-y′ plane parallel to the transverse plane (P_{T}) and support surface (P_{G}). Referring to FIG. 13, the line of sight of the vision sensor 572 is directed at an angle alpha (α) with respect to the horizontal plane (P_{H}). Referring to FIG. 14, the line of sight of the vision sensor 572 is directed at an angle beta (β) with respect to the second vertical plane (P_{V2}). As illustrated in FIGS. 15-17, by directing the line of sight toward the thumb and finger assemblies 564, 566a-566d, the robot 1 may utilize the visual information to determine the finger and thumb positions relative to each other and an object to be grasped.

Referring to FIGS. 12-14, the vision sensor 572 is arranged facing toward the thumb and finger assemblies 564, 566a-566d and the conic section illustrates the field of view of the end effector camera. In the illustrated position, with the palm up and fingers extended, the vision sensor 572 is placed at an angle relative to the horizontal plane or transverse plane. For example, as shown in FIG. 13, when viewed from the side (y′-z′ plane), the angle of the vision sensor 572 may be positioned with a line of sight at a downward-facing angle alpha (α) of about 46.3 to about 69.5 degrees, preferrably about 52.1 to about 63.7 degrees with respect to the horizontal plane (P_{H}) or an angle alpha (α′) of about 25.7 to about 38.5 degrees, preferably about 28.9 to about 35.31 degrees with respect to the first vertical plane (P_{V1}). The line of sight is also angled toward the thumb 564. Referring to FIG. 14, when viewed from the distal end (x′-y′ plane), the vision sensor 572 may be positioned with a line of sight at a downward-facing angle beta (β) of about 59.7 to about 89.6 degrees, preferably about 67.2 to about 82.1 degrees with respect to the horizontal plane (P_{H}), or an angle beta (β′) of about 12.2 to about 18.4 degrees, preferably about 13.8 to about 16.9 degrees with respect to the second vertical plane (P_{V2}). The lens 572.4 of vision sensor 572 can be received within the respective sensor openings in the end effector housing 562 to prevent the lens 572.4 of the vision sensor 572 from being obstructed.

In some embodiments, the electronics assembly 580 may include more than one vision sensor 572 on the end effector 56 at respective mounting positions to provide more views of the thumb and finger assemblies 564, 566a-566d. For example, the end effector electronics assembly 580 may include additional end effector vision sensors (e.g., cameras) arranged on (i) the dorsal surface 562.4.4, (ii) finger assemblies 566, (iii) thumb assembly 564, or (iv) other regions of the end effector housing 562.

While the illustrative vision sensor 572 is primarily shown as embedded in the end effector housing 562 of the end effector 56, it should be understood that: (i) may not be embedded in the end effector; instead, may be integrally formed therewith or directly secured to an outer extent of said end effector, (ii) may be formed in a layer or external covering (e.g., glove) that is positioned on top of or over said end effector, and/or (iii) a combination of any one of the described options. An example of possible combinations include: (i) a portion of the end effector sensor assembly positioned in the glove and a portion of the end effector sensor assembly embedded within the end effector, (ii) a portion of the end effector sensor assembly secured to the exterior of the housing of said end effector and a portion of the end effector sensor assembly embedded within the end effector, (iii) a portion of the end effector sensor assembly positioned in the glove, a portion of the end effector sensor assembly secured to the exterior of the housing of said end effector, and a portion of the end effector sensor assembly embedded within the end effector, (iv) a portion of the end effector sensor assembly positioned in the glove, a portion of the end effector sensor assembly integrally formed with the exterior of the housing of said end effector, and a portion of the end effector sensor assembly embedded within the end effector, and/or (v) any combination of hybrid thereof.

The vision sensor 572 may be in communication with other vision sensors 1.2.8.6 of the robot 1. The vision sensor 572 is primarily for tasks, providing a field of view in front of the robot 1, at the end effectors 56. The vision sensor 572 provides a closer view of the end effector 56 compared to that of the forward facing cameras contained in the head 10. For example, when the robot 1 moves its end effectors 56 in front of the torso 16 to do a task, the end effectors 56 may create blind spots for the upper and lower cameras 108.2.2, 108.2.4 in the head 10.1.

The positions of the vision sensor(s) 572 may be altered to provide a fuller field of view and minimize blind spots. For example, the angles of the vision sensor 572 may be adjusted to provide a fuller field of view and minimize blind spots or dead space. Positioning the vision sensor 572 on the robot's end effector 56 also allows for movement of the vision sensor 572 for better viewing with less movement of the overall robot 1. By moving the robot's arm 5 or end effector 56, the target image within the field of view of the vision sensor 572 is changed and provides a larger, derivative field of view.

Although the vision sensor 572 is shown as a camera in the illustrative example, other sensors may be relied on and coupled to the end effector 56 in a similar manner to ensure proper directional positioning for respective detection, sensing, or signal reception. Said sensors may include: (i) scan camera(s), (ii) monochrome camera(s), (iii) color camera(s), (iv) CMOS camera(s), (v) CCD sensor(s) or camera(s) that include CCD sensor(s), (vi) camera(s) or sensor(s) that have rolling shutter or global shutter, (vii) other types of 2D digital camera(s), (viii) other types of 3D digital camera(s), (ix) camera(s) or sensor(s) that are capable of stereo vision, structured light, and laser triangulation, (x) sonar camera(s) or ultrasonic camera(s), (xi) infrared sensor(s) and/or infrared camera(s), (xii) radar sensor(s), (xiii) LiDAR, (xiv) other structured light sensors, camera(s), or technologies, (xv) dot projecting camera(s) or sensor(s), (xvi) Time-of-Flight (ToF) cameras, (xvii) hyperspectral cameras, (xviii) multispectral cameras, (xix) thermal imaging cameras, (xx) high-speed cameras, (xxi) panoramic cameras, (xxii) omnidirectional cameras, (xxiii) polarization cameras, (xxiv) plenoptic (light field) cameras, (xxv) depth-sensing cameras, (xxvi) ultraviolet (UV) cameras, (xxvii) single-photon avalanche diode (SPAD) cameras, (xxviii) electron-multiplying CCD (EMCCD) cameras, (xxix) short-wave infrared (SWIR) cameras, (xxx) medium-wave infrared (MWIR) cameras, (xxxi) long-wave infrared (LWIR) cameras, (xxxii) quantum dot cameras, (xxxiii) microbolometer cameras, (xxxiv) holographic cameras, (xxxv) optical coherence tomography (OCT) cameras, (xxxvi) spectral imaging cameras, (xxxvii) phase contrast cameras, (xxxviii) interferometric cameras, (xxxix) fiber optic cameras, (xl) terahertz cameras, (xli) millimeter-wave cameras, (xlii) acoustic cameras, (xliii) biometric cameras (e.g., iris recognition cameras), (xliv) artificial compound eye cameras, (xlv) volumetric capture cameras, (xlvi) computational photography cameras, (xlvii) smartphone cameras with advanced sensors, (xlviii) augmented reality (AR) and virtual reality (VR) cameras, (xlix) streak cameras, (l) burst-mode cameras, (li) LiFi (Light Fidelity) cameras, or any combination of the above or any other known camera or sensor. For example, said camera may have a megapixel resolution of between 0.4 MP to 20 MP, may record video at 5.6 FPS to 286 FPS, may have a CMOS sensor, pixel size may range from 2.4 um to 6.9 um, may utilize a starvis rolling shutter technology, can operate in 55 degree c. ambient air temperatures, and may have any other properties, technologies, or features that are discussed within U.S. Pat. Nos. 11,402,726, 11,599,009, 11,333,954, or 11,600,010, all of which are incorporated herein by reference. It should be understood that the cameras are typically configured as video cameras but may have an alternative configuration, such as an image camera.

The information from each vision sensor 572 may be used alone or in combination with the information from the other cameras 108.2.2, 108.2.4, 108.2.6, 108.2.8 and/or sensors included on the robot 1 to aid in the control of the robot 1. The humanoid robot may use information derived from the vision sensor 572 in combination with information derived from other sensors for locomotion planning. The information from the vision sensor 572 may be used to help the robot 1 navigate or locomote on different terrain, localize to different environments and plan routes, and sense and avoid obstacles. The vision sensor 572 may be utilized in similar ways or methods that are discussed within U.S. Patent Application Publication 2005/0267631 and U.S. Pat. Nos. 10,638,906, 10,437,251, 11,020,860, 10,580,208, 11,485,013, 11,759,075, or 10,614,588, all of which are incorporated herein by reference. Other dimensions of said vision sensor 572 are described in the figures and in the below tables. It should also be understood that additional embodiments or alterations to said vision sensor 572 will be discussed below and said embodiments may be partially or fully combined with any of the above described embodiments.

ii. Lower Arm Sensors

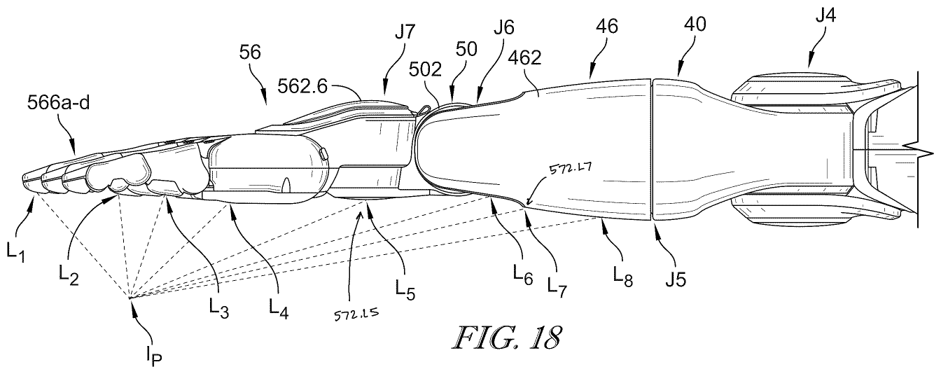

In various embodiments, additional vision sensors or cameras may be mounted to or coupled within the respective housings 462, 502 of the lower forearm 46 and the wrist 50 and directed toward a similar point of interest of the vision sensor 572 housed in the end effector 56. Referring to FIG. 18, examples of various optional locations (L₁-L₈) for vision sensors (e.g., 572.L1-572.L8) are shown, where the lines of sight for the optional vision sensors intersect at a similar point of interest at a distance from the palm surface 562.4.2. As shown, locations L₁-L₄ are alternative locations on the end effector 56 where alternative or additional vision sensors may be positioned. Location L₅ is at the wrist 50. Locations L₆-L₈ are positioned on the lower forearm 46. In various embodiments, illumination sources and/or light emitters of the illumination assembly 1.2.10 may alternatively or additionally be located in similar positions (e.g., locations L₁-L₈) to illuminate the point of interest (I_{P}).

For example, a vision sensor 572.L7 may be positioned on the lower forearm 46 of the arm 5 at an angle so that the vision sensor 572.L7 is directed towards the end effector 56. In another example, a vision sensor 572.L5 may be positioned on the wrist 50 of the arm 5 at an angle so that the vision sensor 572.L5 is directed toward the end effector 56. The forearm and wrist vision sensors 572.L5, 572.L7 aid the vision sensor 572 coupled to the end effector 56 in providing a fuller field of view in front of the robot 1 for when the robot 1 is working to complete different tasks as suggested in FIGS. 15-17.

The vision sensor 572.L7 may be mounted to (i) the outside of the housing 462 of the lower forearm 46, (ii) the inside of the housing 462 of the lower forearm 46, or (iii) the frame of the lower forearm 46 housed within the housing 462. If the vision sensor 572.L7 is mounted within the housing 462, the housing 462 of the lower forearm 46 may have sensor openings for the forearm camera. The lens of the forearm vision sensor 572.L7 may be received within the respective sensor opening to prevent the lens of the forearm vision sensor 572.L7 from being obstructed.

The wrist vision sensor 572.L5 may be mounted to the inside or outside of the housing 502 of the wrist 50. The housing 502 may have a cavity or space formed therein for the wrist vision sensor 572.L5. If the wrist vision sensor 572.L5 is mounted within the housing 502, the housing 502 may have sensor openings for the wrist vision sensor 572.L5. The lens of the wrist vision sensor 572.L5 may be received within the respective sensor opening to prevent the lens of the wrist vision sensor 572.L5 from being obstructed.

The forearm vision sensor 572.L7 and the wrist vision sensor 572.L5 are both arranged in the downward orientation (relative to the palm), like the end effector vision sensor 572, facing toward the end effector 56. The forearm vision sensor 572.L7 and the wrist vision sensor 572.L5 may be placed at the same angle relative to the horizontal plane or transverse plane in some embodiments. The forearm vision sensor 572.L7 and the wrist vision sensor 572.L5 may be placed at the same angle as the end effector vision sensor 572 relative to the horizontal plane (P_{H}). In other embodiments, the forearm vision sensor 572.L7, the wrist vision sensor 572.L5, and the end effector vision sensor 572 may each be placed at different angles relative to the horizontal plane (P_{H}).

Like, the end effector vision sensor 572, the forearm vision sensor 572.L7 and the wrist vision sensor 572.L5 are primarily for tasks, providing a field of view in front of the robot. The forearm vision sensor 572.L7 and the wrist vision sensor 572.L5 are not 360 degree cameras and have fields of view that may be partially obscured. The positions of the forearm vision sensor 572.L7 and the wrist vision sensor 572.L5 may be altered to provide a fuller field of view and minimize blind spots. For example, the angles of the forearm vision sensor 572.L7 and the wrist vision sensor 572.L5 may be adjusted to provide a fuller field of view and minimize blind spots or dead space. Positioning the forearm vision sensor 572.L7 and the wrist vision sensor 572.L5 on the robot's arm 5 also allows for movement of the vision sensors 572.L5, 572.L7 for better viewing with less movement of the overall robot 1. By articulating the arm 5 and the wrist 50, the target image within the fields of view of the vision sensors 572.L5, 572.L7 is changed and provides a larger, derivative field of view.

iii. Finger Sensor Assemblies

The thumb and finger assemblies 564, 566a-566d each houses at least one sensor assembly 568. The sensor assembly 568 is configured to measure the load experienced on the finger assemblies 566a-566d of the end effector 56. The sensor assembly 568 may be located in any one of (i) the proximal assembly 566.4, (ii) the medial assembly 566.6, (iii) the distal assembly 566.8 of each finger assembly 566a-566d, and/or (iv) a combination thereof. In various embodiments, the sensor assembly 568 is located in the distal assembly 566.8. In some embodiments, a sensor assembly 568 may be located in each of the proximal assembly 566.4, the medial assembly 566.6, and the distal assembly 566.8.

Each tactile finger sensor assembly 568 is configured to measure the load experienced on the thumb assembly 564 and/or finger assemblies 566a-566d of the end effector 56 using a strain gauge or arrays of strain gauges. The strain gauges measure strain, which may be used to determine the force, stress, torque, pressure, deflection, etc. experienced on the finger assemblies 566a-566d. The feedback provided by these tactile sensor assemblies 568 embedded in the finger assemblies 566a-566d can be combined with data from the encoders, torque sensors and/or other sensors that are positioned adjacent to or configured to obtain information from each joint. Said combination of feedback, data, and/or information can be used to control the actuation of the finger assemblies 566a-566d, thereby enabling robot 1 to perform complex manipulations that require delicate touch.

The tactile sensor assemblies (i) may be positioned at any location in the end effector (e.g., palm), wrist, foot, or end effector, (ii) may not be embedded in the assembly; instead, may be integrally formed therewith or directly secured to an outer extent of said assembly, (iii) may be formed in a layer or external covering (e.g., protective cover 561) that is positioned on top of or over said assembly, and/or (iv) a combination of any one of the described options. An example of possible combinations include: (i) a portion of the tactile sensor assembly positioned in the glove and a portion of the tactile sensor assembly embedded within the end effector, (ii) a portion of the tactile sensor assembly secured to the exterior of the housing of said end effector and a portion of the tactile sensor assembly embedded within the end effector, (iii) a portion of the tactile sensor assembly positioned in the glove, a portion of the tactile sensor assembly secured to the exterior of the housing of said end effector, and a portion of the tactile sensor assembly embedded within the end effector, (iv) a portion of the tactile sensor assembly positioned in the glove, a portion of the tactile sensor assembly integrally formed with the exterior of the housing of said end effector, and a portion of the tactile sensor assembly embedded within the end effector, and/or (v) any combination of hybrid thereof. As discussed above, the sensor may be incorporated, embedded, and/or attached to the electronics positioned within the housing, the housing, energy absorbing assembly and/or the protective cover.

The strain gauges included in the tactile sensor assemblies may be any type of strain gauge including: (i) linear strain gauges, (ii) double linear strain gauges, (iii) shear or torsional strain gauges, (iv) rosette strain gauges (T (or Tee) shaped, rectangular shaped, delta shaped, stacked), (v) diaphragm strain gauges, (vi) biaxial strain gauges, (vii) bi-directional strain gauges, (viii) stacked strain gauges, (ix) cross strain gauges, (x) double shear, (xi) circular, (xii) any hybrid or combination thereof, and/or (xi) any other suitable strain gauge type that is known to one of skill in the art. The strain gauges may be arranged in different configurations including: (i) quarter-bridge configurations, (ii) half-bridge configurations, and/or (iii) full-bridge configurations.

The strain gauges may also be foil strain gauges, semiconductor strain gauges, thin-film strain gauges, ink based strain gauges, thick-film strain gauges, optical, nanocomposite, and/or any combination or hybrid thereof. Further, the strain gauges may be directly integrated into the housings (interior or exterior), coupled to said housings (interior or exterior) after the housing is manufactured, coupled to another structure (e.g., bridge, spring, etc.) positioned within the housing, integrated into or coupled to the motor or motor housing, positioned between housings, and/or any other known configuration or combination thereof. The foil strain gauges may be made from or include: (i) foils that may be or may include constantan (copper-nickel alloy) karma (nickel-chromium alloy) isoelastic (nickel-iron alloy) evanohm (nickel-chromium alloy) nichrome v (nickel-chromium alloy), and (ii) carrier that may be or may include polyimide film, epoxy or phenolic resin, glass-fiber reinforced epoxy, ceramic backing, and/or polyurethane. Finally, the strain gauges may be any gauge that meets, uses, and/or was tested with at least one of the following standards: ASTM E251-13(2018), Standard Test Methods for Performance Characteristics of Metallic Bonded Resistance Strain Gages, ASTM International, ISO 376:2011, Metallic materials—Calibration of force-proving instruments used for the verification of uniaxial testing machines, ISO 9513:2012, Metallic materials—Calibration of extensometer systems used in uniaxial testing, VDI/VDE 2635 Blatt 2, Experimental structural analysis—Recommendation on the implementation of strain measurements at high temperatures, IEC 61298-3:1998, Process measurement and control devices—General methods and procedures for evaluating performance—Part 3: Tests for the effects of influence quantities, DIN 51301, which is hereby incorporated by reference for all purposes. The strain gauges may be used in combination with other sensors in the sensing assembly or at alternate locations in the robot. Other sensors or technology that may replace or be added to the tactile sensor assemblies are discussed below.

It should be understood that other sensors and/or technology may be used instead of or in combination with the sensor assemblies discussed above. Other strain gauge technology that may be used includes: (i) mems-based strain gauges, (ii) nanocomposite strain gauges, (iii) thin-film or thick-film strain gauges (e.g., C4A Series or EA Series from Vishay Precision Group, RF9 Series or Y Series from Hottinger Brüel & Kjær, KFG Series or KFR Series from Kyowa Electronic Instruments, TFSG Series from BCM Sensor Technologies, SGT Series or KFH Series from Omega Engineering, ELF Series or EPL Series from Meggitt Sensing Systems, or any other known manufacture), (iv) inductive strain gauges, (v) capacitive strain gauges, (vi) piezoelectric strain gauges, (vii) optical fiber strain gauges, (viii) semiconductor strain gauges, and/or (ix) a hybrid or combination thereof. The strain gauges provide measurements with high accuracy, but may lack high resolution. The additional sensors used in combination with the strain gauges in the sensor assembly would help provide a higher resolution. Alternative or additional sensors/technology may include photodiodes, Hall Effect sensors, capacitive sensors, piezoelectric sensors, piezoresistive sensors, optical sensors, force-sensitive resistors (FSRs), magnetic sensors, inductive sensors, micro-electro-mechanical systems (MEMS) sensors, dielectric elastomer sensors, quantum tunneling composite (QTC) sensors, fiber Bragg grating sensors, ultrasonic sensors, thermal sensors, electroactive polymers, triboelectric nanogenerators (TENGs), linear variable differential transformers (LVDTs), flex sensors, acoustic emission sensors, resistive touch sensors, proximity sensors, hydrogel-based sensors, smart skin technologies, magnetoelastic sensors, capacitive micromachined ultrasonic transducers (CMUTs), pressure-sensitive adhesives, electromagnetic acoustic transducers (EMATs), photonic crystal sensors, laser doppler vibrometers, electrical impedance tomography sensors, graphene-based sensors, nanowire sensors, electronic skin (e-skin) sensors, carbon nanotube-based sensors, barometric pressure sensors, eddy current sensors, microfluidic tactile sensors, nanogenerators, stretchable electronic sensors, force torque sensors, rheological sensors, haptic feedback sensors, polymer nanofiber sensors, ionic liquid-based sensors, thermocouple sensors, touch-sensitive field-effect transistors, terahertz radiation sensors, radar sensors, LIDAR sensors, infrared touch sensors, humidity sensors, mechanical limit switches, pressure mapping sensors, distributed fiber optic sensors, magnetostrictive sensors, optoelectronic sensors, surface acoustic wave (SAW) sensors, capaciflectance sensors, tribo-skin sensors, spintronic sensors, photonic touch sensors, acoustic resonant sensors, and capacitive tomography sensors, or any other suitable technology that is known to one of skill in the art.

d. Protective Cover

Referring to FIGS. 4-6, the end effector 56 may include a protective cover 561 that is part of the cover system 1.2.16 and designed to help safeguard the end effector assemblies 56 of the robot 1. The protective cover 561 may be a detachably removable cover arranged external to the end effector housing 562 to substantially cover the end effector 56. The protective cover 561 may be configured as a form-fitting glove and may include a main portion 561.2 to substantially cover the main enclosure 562.4 and a thumb portion 561.4 and finger portions 561.6a-d extending from the main portion 561.2 to substantially cover the thumb assembly 564 and the finger assemblies 566a-d, respectively. The main portion 561.2 may form a palmer region and a dorsal region, while the thumb and finger portions may form a thumb region and a finger region. The protective cover 561 is configured to accommodate the vision sensor 572 without obstructing the field of view. For example, the protective cover 561 may include a sensor region 561.2.2 shaped to surround or couple with the sensor mounting frame 562.4.2.4, ensuring the cover does not overline the lens of the vision sensor.

The protective cover 561 may include means of securement to detachably attach the glove to the end effector 56. For example, the protective cover 561 may include an elastic loop 561.8 that can be stretched to be detachably secured in the attachment channel 562.6.2.2 of the actuator cover 562.6 at the proximal end portion of the end effector housing 562. Optionally, the elastic loop 561.8 may include a tab or other means for grasping the elastic loop 561.8 to install or remove the protective cover 561.

The protective cover 561 is configured to stretch as the finger assemblies 566 and thumb assembly 564 bend at the joints. The protective cover 561 is shaped and sized to be slid over the finger assemblies 566 and thumb assembly 564, and to cover an extent of the dorsal surface 562.4.4 and the palm surface 562.4.2 of the main enclosure 562.4 of the end effector 56. The protective cover 561 is a form fitting protective cover configured to protect a substantial portion of the end effector 56. In some embodiments, first and second energy attenuation members may be affixed to a portion of the finger assembly 566a and thumb assembly 564, respectively. For instance, the end effector housing 562, the thumb assembly 564, and/or the finger assemblies 566a-d may include energy attenuation members affixed to their respective housings and positioned beneath the protective cover 561. The protective cover 561 may be made from a durable material that stretches. In various embodiments, the protective cover 561 may be made from the same textile covering as other components of the cover system 1.2.16.

In other embodiments, the protective cover 561 may be: (i) integrated or formed with an extent of the housing of the end effector, (ii) external to the housing of the end effector, and partially cover an extent (e.g., tips, joints, or both) of said end effector housing, (iii) external to the housing of the end effector, and completely cover the end effector housing, (iv) external to the housing of the end effector, and completely cover the end effector housing and other extents, parts, and/or components (e.g., wrist, forearm, elbow, etc.) of the robot 1. Additionally, said protective covering may be selected based on the specific tasks to be performed by the robot 1 in the designated operating environment.

### 5. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the leg assembly may incorporate features such as hard-stops, cooling channels, heat sinks, or other materials, structures, components, or assemblies described herein. For example, a heat pipe may extend from the knee to the shin 84. Furthermore, the talus 88 may include a quick-release mechanism that enables the interchange of a different foot 92. Moreover, the housing of each component may be designed with internal reinforcement structures, may be made from various materials (e.g., metal alloys or advanced materials like carbon-fiber-reinforced polymers).

To enhance the stability and adaptability of the humanoid robot 1, the leg assemblies 6 may incorporate advanced sensing and control systems, as well as comprehensive protective systems. For instance, force sensors located in the feet 92 and ankles may provide real-time feedback on ground contact forces and pressure distribution. This data may be used by the control system of the humanoid robot 1 to make rapid adjustments in order to maintain balance, especially when moving on uneven or dynamic surfaces. Inertial measurement units (IMUs) positioned in the leg assemblies 6 and the pelvis 64 may also provide information on the orientation and acceleration of each leg segment, thereby allowing for the precise control of leg positioning during movement.

b. Mechanical and Electrical Architecture

The mechanical and electrical architecture 1.2 may be embodied as any combination of hardware, software, and circuitry that enables the humanoid robot 1 to operate and perform physical functions in response to electrical charges or electrical signals. As illustrated comprehensively in additional figures herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) typically lack the versatility and effectiveness that are needed to perform such a diverse array of generalized tasks.

i. Actuators

The actuators 1.2.4 contained within the robot 1 include thirty actuators (J1)-(J16), excluding the end effectors, that are housed within various components of the robot 1 to actuate movement of said components. An additional aggregate total of twelve actuators are in both end effectors 56 combined. Below is a summary table showing the actuator 1.2.4 reference names and numbers for the thirty actuators (J1)-(J16), the quantity of each, descriptive actuator names used herein for consistency, common corresponding informal actuator names, and associated rotational axes from the high-level configuration of the illustrative embodiment robot 1. Specific actuators in each end effector 56 (e.g., six actuators in each end effector) are not individually included in the below table.

TABLE 1

| | | Actuator | | |
|---|---|---|---|---|
| Actuator | Qty | Name | Informal Actuator Name(s) | Axis |
| (J1) 190 | 2 | arm | primary arm | A₁ |
| (J2) 280 | 2 | shoulder | (none) | A₂ |
| (J3) 320 | 2 | upper | upper arm x, upper arm roll | A₃ |
| | | arm twist | | |
| (J4) 374 | 2 | elbow | arm z, arm yaw, | A₄ |
| | | | lower humerus | |
| (J5) 468 | 2 | lower | lower arm x, lower arm roll | A₅ |
| | | arm twist | | |
| (J6) 484 | 2 | wrist flex | wrist/hand y, wrist/hand pitch, | A₆ |
| | | | flick | |
| (J7) 520 | 2 | wrist pivot | wrist/hand z, wrist/hand yaw, | A₇ |
| | | | wave | |
| (J8.1) 120 | 1 | head twist | head no | A_{8.1} |
| (J8.2) 140 | 1 | head nod | head yes | A_{8.2} |
| (J9) 680 | 1 | torso lean | spine x, torso/spine roll | A₉ |
| (J10) 620 | 1 | torso twist | spine z, torso/spine yaw | A₁₀ |
| (J11) 720 | 2 | hip flex | hip y, hip/leg pitch, forward kick | A₁₁ |
| (J12) 768 | 2 | hip roll | hip x, hip/leg roll, sideways kick | A₁₂ |
| (J13) 782 | 2 | leg twist | hip z, hip/leg yaw | A₁₃ |
| (J14) 820 | 2 | knee | lower thigh, lower leg y, | A₁₄ |
| | | | lower leg pitch, rear kick | |
| (J15) 860 | 2 | foot flex | foot y, foot pitch, or first ankle | A₁₅ |
| (J16) 900 | 2 | foot roll | talus, foot roll, foot x, second | A₁₆ |
| | | | ankle | |

It should be understood that in other embodiments, some of these systems, assemblies, components, and/or parts may be omitted, combined, or replaced with alternative systems, assemblies, components, and/or parts.

A substantial majority of the actuators 1.2.4 (e.g., about twenty-eight of the forty-two actuators or about 66.7% of the actuators) in the illustrative embodiment robot 1 are not connected to a drive linkage; instead, they directly drive the associated part of the robot 1. Conversely, in the illustrative embodiment robot 1, fourteen of the forty-two actuators 1.2.4, or about 33.3% (but more than 10%, and preferably more than 25%), of the rotary actuators are coupled to a drive linkage. Drive linkages are coupled to an aggregate total of twelve rotary actuators contained within both end effectors 56 and to the foot flex actuators (J15) in each shin 84. These drive linkages allow: (i) the fingers and thumb to be under-actuated, meaning they retain the ability to flex, curl, or rotate around an object while eliminating the need for an actuator to control each joint or degree of freedom, and (ii) the foot 92 to pivot around an axis that is located well forward (e.g., more than 10% of the overall length of the foot) of the center of the drive linkage.

The robot 1 only uses electric actuators, and thereby lacks manual, hydraulic, cable-based, or pneumatic actuators. The exclusive use of electric actuators reduces assembly, maintenance, weight, and cost, and increases durability and safety considerations related to operating the robot 1 within or around other humans.

ii. Cover System

The illustrative embodiment robot 1 includes various components (e.g., assemblies) with housings 1.2.2 (e.g., to form an exoskeleton) that are designed to protect the operational systems of the robot 1, such as actuators 1.2.4 and electronics assembly 1.2.6, provide structural support, and give form to the robot 1. Said housings 1.2.2 can be comprised of hard or rigid casings that may include internal mounting features designed to support systems in specific locations, structural features engineered to withstand operational loads, and internal and/or external features that allow for interoperation between adjacent components and/or are formed to resemble human features. Some housings 1.2.2 additionally include one or more detachable shells that may overlay a casing to allow access to internal assemblies or to complete the form of the component.

The characteristics of the housings 1.2.2 can vary in shape and form based on the individual structural or material specifications for each specific component. While it may be desirable to utilize a particular material for all housings 1.2.2 to create a consistent exterior appearance, fabrication may be complicated by specific structural or operational needs at different locations. It may not be necessary to utilize the same materials in different housings 1.2.2 that experience different load conditions. Various materials may be preferred for a specific housing 1.2.2 based on properties such as strength, toughness, elasticity, weight, and conductivity. Similarly, the complexity of some housing 1.2.2 designs may be better suited for one type of manufacturing process, such as machining, die casting, injection molding, or composite fabrication, over another. Because there is a desire or need to use different materials within different regions and/or use materials that do not have a consistent exterior appearance, the illustrative embodiment robot 1 includes exterior coverings of the cover system 1.2.16 that are designed to at least partially hide the housings 1.2.2 under a textile exterior layer that can be easily swapped if damaged, serve to protect internal components from dust and debris, are designed to fit the form of the robot 1 without substantial wrinkling, and/or allow for venting or address thermal considerations at specified locations.

The exterior coverings may have a multi-layered assembly, which may include: (i) an energy-absorbing material that is coupled to the coupling layer, (ii) a coupling layer (e.g., plastic or polymer based), wherein the coupling layer facilitates attachment to, or attachment at, a housing 1.2.2, and/or (iii) an exterior coverings material (e.g., a textile). Alternatively, the multi-layered assembly may omit the coupling layer, the energy-absorbing material, and/or exterior covering material. In each case, the movement of the nearby joint may cause one housing 1.2.2 to impact or crush the energy absorbing layer instead of another housing 1.2.2, thereby mitigating or eliminating structural stress or load on either housing 1.2.2 and/or the respective actuator 1.2.4. Additionally, the energy attenuation members help to reduce pinch points, and/or allow for a more human-like appearance.

### 1. Energy Attenuation Assembly

The energy attenuation assembly may be composed of a plurality of integrated or removable energy attenuation members, such as pads, panels, or bumpers, that are attached to housings 1.2.2 of the robot 1 and/or are positioned within the external covers. Said energy attenuation members may: (i) be attached directly to a particular exterior side of a housing 1.2.2 (e.g., overlie the housing), (ii) surround an exterior of a housing 1.2.2 and not be directly attached (e.g., friction fit), (iii) be attached to the edges of an opening formed in the housing 1.2.2 (e.g., act as a deformational extent of the housing), and/or (iv) be attached to or retained by the exterior coverings.

The disclosed robot 1 includes a torso energy attenuation member, elbow energy attenuation members, and leg energy attenuation members. Additionally, energy attenuation members may be included at the hip, shin, and/or foot. Some or all energy attenuation members may also be omitted. Energy attenuation members can be configured to enhance or alter the shape of the robot 1 without adding substantial weight and to provide a deformable structure with energy absorption properties to protect underlying components.

The energy attenuation members can be made from a wide variety of materials, including: (i) polymers, such as polyethylene foam (PE Foam), ethylene vinyl acetate (EVA) foam, polyurethane foam (including Memory Foam and Open-cell Polyurethane Foam); (ii) rubber foams; (iii) natural foams; (iv) engineered foams; (v) composite and hybrid materials; (vi) expanded polystyrene (EPS); (vii) expanded polypropylene (EPP); (viii) Koroyd®; (ix) D3O®; (x) Poron® XRD; (xi) thermoplastic elastomers (TPE) or thermoplastic polyurethane (TPU); (xii) any other material known to one of skill in the art that accomplishes the desired energy absorption characteristics; (xiii) any combination of the above. Furthermore, the energy-absorbing material may alternatively or additionally include other structures of said materials, wherein said structures may include lattices and/or repeating units, such as a cube, sphere, cylinder, cone, pyramid, torus, prism, tetrahedron, dodecahedron, octahedron, icosahedron, ellipsoid, paraboloid, cuboid, or hexahedron. It should be understood that the repeating unit or lattice cell may be contained in a specific region or may propagate throughout the entire energy attenuation member. Additionally, the energy attenuation members and/or the assembly may have varying properties, such as thickness, density, C/D ratio, and stiffness. This variation may be arranged in a gradient manner, wherein the energy-absorbing materials transition from softer to firmer layers or regions to provide progressive energy dissipation.

### 2. Exterior Coverings

The exterior coverings, which can include a neck cover, a torso cover, an upper leg cover, a shin cover, a foot cover, a lower arm cover, and an end effector cover, are designed not to interfere with the robot's range of motion, to allow access to underlying components, to potentially add indicators to the external surface, and to improve the robot's overall aesthetic appearance. As shown in the figures, a single exterior covering does not extend over all actuators in the robot 1, and typically does not cover more than five actuators at a time. In other words, the exterior covering does not resemble an oversized jumpsuit with a closure running from, e.g., the robot's pelvis to its head region, nor does it include a hood that extends around a substantial portion of the robot's head. Instead, the exterior covering is strategically and tightly fitted in certain regions and may include different inserts (e.g., a different textile) that are positioned between the moving aspects of joints.

Exterior covering materials of the cover system 1.2.16 can be made from one or more textiles and can be customized or selected to reduce wrinkling and to allow for the twisting or movement of the underlying components without restriction or substantial distortion. For example, the exterior covering materials may be designed to allow the lower arm to twist and rotate from about −120 degrees to about 180 degrees. Additionally, the exterior covering materials may be selected to allow for the cooling of components, the viewing of indicator lights, or the operation of buttons through said exterior coverings. This provides a substantial benefit over conventional systems that lack these advanced features. It should be understood that this disclosure contemplates using or including exterior covering materials that: (i) integrate lights from the robot 1 into said exterior covering, and specifically into a textile itself, (ii) may be translucent or temporarily translucent (e.g., based on time or environment), and/or (iii) can be formed (e.g., woven) in a manner that allows light to be transmitted through the textile.

As such, various types of lights (e.g., fiber optic lighting, led strip lights, led rope lights, micro-led string lights, led neon flex, phosphorescent paint, OLED panels (organic light-emitting diode), laser diode lighting, neon tubing, electroluminescent panels, led edge-lit panels, flexible led sheets, flexible OLED strips, inductive electroluminescent displays, laser fiber cables, quantum dot light-emitting displays, phosphor-coated led strips, laser-activated fluorescent materials, electroluminescent paint, laser-illuminated fiber bunches, phosphor-coated electroluminescent (PCEL) materials, smart RGB led strips, light-up silicone tubing (LED or EL-based), laser wire, or other electroluminescent materials such as EL wire, EL tape, or EL film) that are coupled to the humanoid robot 1 may be visible through the exterior coverings material. The exterior covering material can include reflective yarn or night-luminous yarn that changes its appearance when light is shining on its surface. In other embodiments, a shiny, reflective, iridescent, matte, or textured polyurethane film can be applied to the surface of the exterior covering material (e.g., a textile) in certain areas to provide an additional reflective effect or for another purpose, such as displaying a logo, pattern, or labels.

The exterior covering material can also include features to accommodate the thermal considerations of the robot 1. In various examples, the exterior covering material can be a custom textile that utilizes different weaves in different locations to allow for ventilation in specific areas. Additionally, the exterior coverings material can include textiles or threads that are heat-sensitive and change color with a change in temperature. In summary, the exterior covering may additionally be made from, include, or specifically omit any one or any combination of the following material types: durable materials, flame-resistant materials, waterproof materials, hazard materials, chemical-resistant materials.

Alternatively or additionally, the cover system 1.2.16 may include features such as closures (e.g., a zipper that runs a partial or full length of the cover system 1.2.16), attachment points, couplers, self-cleaning nanocoatings, thermoelectric materials, photochromic dyes, or electromagnetic shielding layers, as well as modular, quick-release panels or e-textile technology with conductive fibers woven throughout to create a distributed sensor network that is capable of detecting impacts, monitoring joint angles, or even harvesting energy from movement. The cover system 1.2.16 may be designed to include inserts (which may also be textiles or may be other materials) that are positioned strategically between moving joint components to further ensure that pivoting motion is not restricted at the joints of the humanoid robot 1. Different textile materials, patterns, knits, weaves, etc. may be incorporated to facilitate movement in specific regions, thereby enhancing the functional dexterity of the robot 1.

iii. Sensors

The sensors 1.2.8 may be embodied as any hardware, software, and/or circuitry for providing sensor data indicative of perceived stimuli, conditions, and measurements to enable the humanoid robot 1 to process, reason, and act appropriately (e.g., based on a given task, a set of rules, and/or other constraints). The sensors 1.2.8 may include one or more torque sensors 1.2.8.2, inertial sensors 1.2.8.4, vision sensors 1.2.8.6, auditory sensors 1.2.8.8, touch sensors 1.2.8.10, proximity sensors 1.2.8.12, environmental sensors 1.2.8.14, and other sensors 1.2.8.16. The sensors 1.2.8 may provide sensor data (e.g., torque, inertia measures, audio-visual sensor data, touch data, proximity data, environmental data, etc.) to the compute 1000 processors, further described below, to enable appropriate interaction between the humanoid robot 1 and the environment.

The torque sensors 1.2.8.2 may comprise one or more torque cells that are positioned within the actuators and are designed to measure the amount of force or torque applied to a part of the humanoid robot 1. The measurements may be transmitted to other components of the humanoid robot 1, such as the whole body controller 1550 or one or more controllers 1600, to enable balance, locomotion, manipulation, and handling by the humanoid robot 1.

The inertial sensors 1.2.8.4 may comprise sensors for measuring the motion, position, and orientation of the humanoid robot 1 relative to the environment for purposes of navigation, stabilization, and interaction with the environment and surroundings. For example, the inertial sensors 1.2.8.4 can include one or more accelerometers (e.g., to measure acceleration forces in one or more directions for use in determining changes in velocity and orientation), gyroscopes (e.g., to measure angular velocity for use in tracking rotational movement and maintaining balance), IMUs (e.g., combining the accelerometers and gyroscopes for use in providing comprehensive motion and orientation data), and Global Positioning System (GPS) receivers (e.g., to provide location data based on satellite signals, for use in outdoor navigation and positioning).

The vision sensors 1.2.8.6 may comprise sensors for capturing vision data, including cameras (e.g., red-green-blue (RGB) standard color cameras, grayscale monocular cameras, and stereo cameras (e.g., to capture depth perception)), depth cameras (e.g., depth cameras using technologies such as structured light or time-of-flight to measure distance to objects, Azure® Kinect® depth camera, Intel® RealSense® depth camera, etc.), LIDAR (Light Detection and Ranging) sensors (e.g., to measure distance to objects by emitting laser pulses, analyze the reflections, and provide detailed 2D or 3D maps of the environment), radar (e.g., to detect objects via radio waves and measure distance and speed for use in various applications including navigation and obstacle detection). Vision sensors 1.2.8.6 may also include event-based cameras, which report changes in pixel intensity rather than full frames, offering advantages in speed and data efficiency for dynamic scenes. Examples of said vision sensors 1.2.8.6 include the cameras 108.2.2 and 108.2.4 contained in the head 10.1 of the robot 1.

The auditory sensors 1.2.8.8 may comprise sensors for capturing audio data, including microphones (e.g., to capture audio signals for voice recognition, environmental noise detection, or communication), ultrasonic transducers (e.g., to capture distance measurement and obstacle detection through high-frequency sound waves), spatial audio sensors such as microphone arrays and direction of arrival sensors (e.g., to capture sound from different locations to determine the direction and distance of sound sources for 3D positioning). Auditory sensors 1.2.8.8 could also include specialized acoustic sensors for detecting specific sound patterns, such as the sound of failing machinery or distress calls, further enhancing the robot's environmental awareness.

The touch sensors 1.2.8.10 may comprise sensors for detecting physical contact or pressure applied to the surface of the humanoid robot 1, e.g., to enable tactile feedback, safety and collision avoidance, object handling and manipulation, and interaction with the environment and surroundings. Example touch sensors 1.2.8.10 may include pressure sensors to measure an amount of pressure applied to a surface by the humanoid robot 1, such as capacitive sensors (e.g., to detect touch or proximity through changes in capacitance), resistive sensors (e.g., to detect pressure or touch by measuring changes in resistance), piezoelectric sensors (e.g., to generate an electrical charge in response to mechanical stress or pressure and detect vibrations or impact), force-sensitive resistors (e.g., to change resistance based on the amount of applied force), and optical touch sensors (e.g., to use light beams or infrared to detect touches or proximity). Alternative touch sensors 1.2.8.10 may involve artificial skin technologies that provide a more distributed and nuanced sense of touch, capable of detecting not only contact but also shear forces and temperature changes on the robot's surfaces.

The proximity sensors 1.2.8.12 may comprise sensors for detecting the presence or absence of objects within a given range without necessarily making physical contact with the object, e.g., to provide obstacle avoidance, navigation, and object detection. Example proximity sensors 1.2.8.12 can include ultrasonic sensors (e.g., to measure distance by emitting ultrasonic waves and detecting reflection of the waves for avoiding obstacles and measuring distance) and infrared rangefinders (e.g., to detect, using infrared light, the presence or distance of objects for proximity sensing and simple obstacle detection). Capacitive proximity sensors may also be used as part of proximity sensors 1.2.8.12, particularly for close-range interactions.

The environmental sensors 1.2.8.14 may comprise sensors for measuring various physical parameters of the environment and surroundings to enable the humanoid robot 1 to interact with the environment and surroundings, adapt to changes in the environment and surroundings, and perform a given task. Example environmental sensors 1.2.8.14 can include thermocouples (e.g., to measure temperature by generating a voltage proportional to temperature difference), thermistors (e.g., to measure temperature based on changes in resistance), magnetometers (e.g., to measure magnetic fields for navigation and orientation), light sensors (e.g., to measure intensity of light in the environment), gas sensors (e.g., to detect presence and concentration of various gases and monitor air quality), and humidity sensors (e.g., to measure relative humidity in the air). Other environmental sensors 1.2.8.14 could include barometric pressure sensors for altitude determination or weather prediction, radiation sensors for operation in hazardous environments, or particulate matter sensors for air quality assessment in industrial settings.

iv. Communication Interfaces

The communication interfaces 1.2.12 may be embodied as any hardware, software, or circuitry to enable the exchange of data, signals, and other forms of communication between different components within the humanoid robot 1, and between the humanoid robot 1 and other systems (e.g., other humanoid robots 2700A-X, the command centers 2750A-X, the remote AI system 2780), and other components and devices interconnected over the networks 2999A-X. Specifically, the humanoid robot 1 may be configured with a variety of communication interfaces 1.2.12. The communication interfaces 1.2.12 may be embodied as any combination of a communication circuit, device, or collection thereof, capable of enabling communications over a network (e.g., the networks 2999A-X). The communication interfaces 1.2.12 may be configured to use any one or more communication technology (e.g., wired or wireless communications) and associated protocols to effect such communication.

Various examples of communication interfaces 1.2.12 include a wireless communication interface 1.2.12.2 (e.g., Bluetooth®, Wi-Fi®, WiMAX, Cellular (e.g., 3G, 4G, 5G), Zigbee, LoRa (Long Range) and RF (Radio Frequency)), a wired communication interface 1.2.12.4 (e.g., Ethernet, USB, Serial Communication (e.g., RS-232, RS-485), and Controller Area Network (CAN) interface)), a local communication interface 1.2.12.6 (e.g., an I2C (Inter-Integrated Circuit), SPI (Serial Peripheral Interface)), and a human-robot communication interface 1.2.12.8 (e.g., voice recognition systems to enable communication through spoken commands using speech recognition technology, touch interfaces such as touchscreens or physical buttons for direct human interaction with the humanoid robot 1). Alternatively or additionally, the human-robot communication interface 1.2.12.8 may include gesture recognition systems or gaze tracking, allowing for more intuitive and non-verbal interaction with human operators. The communication interfaces 1.2.12 may also include a network interface controller (NIC) (not illustrated), which may also be referred to as a host fabric interface (HFI). The NIC may be embodied as one or more add-in-boards, daughtercards, controller chips, chipsets, or other devices that may be used by the humanoid robot 1 for network communications with remote devices.

c. Compute

As illustrated in FIG. 2, the compute 1000 may comprise any combination of hardware, software, and circuitry to perform various computing functions that enable the humanoid robot 1 to operate semi- or fully-autonomously. Specifically, the compute 1000 includes: (i) compute hardware 1010, and (ii) computing architecture 1100. Such functions may include processing long-horizon goals, coordinating with other humanoid robots 2700A-X, processing sensor information, controlling the humanoid robot 1 based on the sensor information and goals, controlling the activation or deactivation of mechanical components, learning, simulating, refining behavioral models, and policy management.

i. Hardware

The compute hardware 1010 may operate as one or more general purpose processors or special purpose processors (e.g., digital signal processors, application specific integrated circuits (ASICs), field programmable gate arrays (FPGAs), etc.) that can be configured to execute computer-readable program instructions stored in the aforementioned data storage devices. Such instructions can be executed to provide controller operations (e.g., to activate or deactivate components of the mechanical and electrical architecture 1.2, etc.). Specifically, the humanoid robot 1 may be configured with a variety of processors such as one or more central processing units (CPUs) 1100 (e.g., x86 CPUs, ARM CPUs, RISC-V CPUs, embedded CPUs such as Internet-of-Things CPUs or mobile CPUs), graphics processing units (GPUs) (e.g., ray tracing GPUs, accelerated computing GPUs, embedded GPUs such as system-on-chip (SoC) GPUs or mobile GPUs), neural network processing units (for example, tensor processing units designed for tensor computations in machine learning tasks; dedicated neural network processing units such as Intel Nervana NNP, Graphcore IPU, IBM TrueNorth, or Qualcomm Cloud AI 100; custom neural network processing units such as Amazon Web Services (AWS) Inferentia, Apple Neural Engine, and Huawei Ascend; and Neuromorphic Neural Network Processing Units such as Intel Loihi or BrainChip Akida), and other processors. For example, the other processors may be embodied as a single or multi-core processor, a microcontroller, or other processor or processing/controlling circuit. In some embodiments, the other processors may be embodied as, include, or be coupled to an FPGA, an ASIC, reconfigurable hardware or hardware circuitry, or other specialized hardware to facilitate the performance of the functions described herein.

ii. Architecture

The computing architecture 1100 includes: (i) a movement controller 1302, (ii) a behavior manager 1350, (iii) a perception system 1420, (iv) a local AI system 1470, (v) a whole body controller 1550, (vi) one or more controllers 1600, and (vii) other subcomponents 1650.

### E. Industrial Application

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as either an “end effector” or a “hand assembly.”

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut-shaped work envelope, with two parallel joints that provide compliance in one selected plane, with rotary shafts positioned vertically, with an end effector attached to an arm, etc.), a delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such a feature is included in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. patent application Ser. Nos. 18/919,263, 18/919,274, 18/922,334, 19/000,626, 19/006,191, 19/033,973, 19/038,657, 19/064,596, 19/066,122, 19/180,106, 19/223,945, 19/224,109, 19/224,252, 19/249,517, 19/252,392, 19/252,708, 19/306,591, 19/319,712, 19/324,392, 19/323,751, 19/325,486, 19/325,415, 19/324,342, 19/329,008, 19/329,474, 19/329,485, 19/329,559, 19/337,845, 19/337,852, and 19/337,899; and (iii) U.S. Design patent application Ser. Nos. 29/889,764, 29/928,748, 29/935,680, 29/954,572, 29/967,462, 29/993,115, 29/998,761, 30/024,341, and 30/024,351; (iv) U.S. Provisional Patent Application Nos. 63/556,102, 63/557,874, 63/558,373, 63/561,307, 63/561,311, 63/561,313, 63/561,315, 63/561,317, 63/561,318, 63/564,741, 63/565,077, 63/573,226, 63/573,528, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, and 63/841,314, each of which is expressly incorporated by reference herein in its entirety.

In this application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A humanoid robot comprising:
a torso;
a head coupled to the torso;
an arm assembly coupled to the torso at a proximal end of the arm assembly; and
an end effector coupled to the arm assembly at a distal end of the arm assembly, wherein the end effector has a palmer side and a dorsal side and includes:
a thumb assembly having at least three degrees of freedom,
a first finger assembly having at least two degrees of freedom, and
a vision sensor coupled to a portion of the end effector,
wherein the vision sensor is configured to have a field of view that includes a majority of the palmer side of said end effector, and whereby said field of view enables the vision sensor to detect information about contact between an object and one or more of: (i) an extent of the thumb assembly, and (ii) an extent of the first finger assembly.

2. The humanoid robot of claim 1, wherein the end effector is coupled to the arm assembly via a wrist, and wherein the vision sensor is oriented on the palmer side and positioned at the wrist.

3. The humanoid robot of claim 1, wherein the vision sensor is oriented on the palmer side and positioned between a distal end of the arm assembly and the first finger assembly.

4. The humanoid robot of claim 1, wherein the end effector further includes an illumination source arranged to illuminate at least a majority of the field of view between: (i) the vision sensor and, (ii) the extent of the thumb and the extent of the first finger assembly, as determined while the humanoid robot is in an extended state.

5. The humanoid robot of claim 1, wherein at least one of the thumb assembly and the finger assembly includes a tactile sensor comprising a strain gauge at a distal end of the thumb assembly and/or a distal end of the finger assembly.

6. The humanoid robot of claim 1, further comprising a detachably removable protective cover configured to overlie a majority of the end effector but not obstruct the field of view of the vision sensor.

7. The humanoid robot of claim 6, wherein the end effector further includes a wrist actuator housing with a channel, and wherein the protective cover is configured as a glove with an extent of the glove detachably secured to the channel.

8. The humanoid robot of claim 1, wherein the vision sensor comprises a first imaging detector, and wherein the head includes a second imaging detector that is identical to the first imaging detector.

9. The humanoid robot of claim 1, wherein the end effector further includes a heat sink positioned at a dorsal side of the end effector.

10. The humanoid robot of claim 1, wherein the information about contact is used, at least in part, to control movement of the first finger assembly and movement of the thumb assembly.

11. A humanoid robot comprising:
a torso;
a head coupled to the torso;
an arm assembly coupled to the torso; and
an end effector coupled to the arm assembly, wherein the end effector includes:
a first finger assembly having: (i) a respective operational space, (ii) a first energy attenuation member affixed to a portion of the first finger assembly, and (iii) a respective distal assembly with a respective tactile sensor positioned therein,
a thumb assembly positioned adjacent to the first finger assembly and having: (i) a respective operational space, (ii) a second energy attenuation member affixed to a portion of the thumb assembly, and (iii) a respective distal assembly with a respective tactile sensor positioned therein, and
a vision sensor positioned near both the thumb assembly and the finger assembly and having a field of view that includes the respective operational space of the first finger and at least a majority of the respective operational space of the thumb.

12. The humanoid robot of claim 11, wherein the arm assembly includes a wrist, wherein the end effector is coupled to the arm assembly via the wrist, and wherein the vision sensor is positioned proximate to the wrist.

13. The humanoid robot of claim 11, wherein the end effector has: (i) a proximal end at which the end effector is coupled to the arm assembly, and (ii) a first side towards which the finger assembly is configured to curl, wherein the vision sensor is positioned between the proximal end of the end effector and the first finger assembly and the field of view includes at least a portion of the first side of the end effector.

14. The humanoid robot of claim 11, wherein the end effector further includes an illumination source arranged to illuminate at least a portion of the respective operational space of the first finger assembly and at least a portion of the respective operational space of the thumb.

15. The humanoid robot of claim 11, further comprising a form-fitting glove with a palmer region, a dorsal region, a finger region, and a thumb region, wherein the form-fitting glove is detachably positioned over at least a portion the end effector, wherein the form-fitting glove has a sensor region formed therein that does not cover the vision sensor.

16. The humanoid robot of claim 11, wherein end effector further includes a control assembly configured to control motion of the first finger assembly and motion of the thumb assembly.

17. The humanoid robot of claim 11, wherein, as determined while the humanoid robot is in an extended state, the vision sensor is positioned at a downward-facing angle of about 45 to about 70 degrees with respect to a horizontal plane (PH), wherein the horizontal plane is parallel to a transverse plane of the humanoid robot and extends through the vision sensor.

18. The humanoid robot of claim 11, wherein, as determined while the humanoid robot is in an extended state, the vision sensor is positioned at a downward-facing angle of about 12 to about 19 degrees with respect to a vertical plane (PV2), wherein the vertical plane is parallel to a coronal plane of the humanoid robot and extends through the vision sensor.

19. The humanoid robot of claim 11, wherein the end effector includes a palm surface, and wherein the vision sensor is coupled to the palm surface.

20. The humanoid robot of claim 11, wherein the humanoid robot uses information derived from the vision sensor in combination with information derived from other sensors for locomotion planning.

21. A humanoid robot comprising:
a torso;
a head coupled to the torso;
an arm assembly coupled to the torso; and
an end effector coupled to the arm assembly, wherein the end effector includes:
a thumb assembly coupled to a first portion of the end effector,
a first finger assembly coupled to a second portion of the end effector,
a sensor mounting frame coupled to a third portion of the end effector that is positioned between a distal extent of the arm and a majority of the first finger assembly, and
a vision sensor mounted to the sensor mounting frame and including:
an imaging detector,
a lens that overlies and protects the imaging detector, and
an illumination source positioned near the image detector.

22. The humanoid robot of claim 21, wherein the end effector includes a palmer side and a dorsal side, and wherein the vision sensor is coupled to the end effector on the palmer side of the end effector.

23. The humanoid robot of claim 21, wherein the illumination source is arranged to illuminate a spatial region between the imaging detector and a distal end of the first finger assembly.

24. The humanoid robot of claim 21, wherein at least one of the thumb assembly and the finger assembly includes a tactile sensor comprising a strain gauge at a distal end of the thumb assembly and/or a distal end of the finger assembly.

25. The humanoid robot of claim 21, further comprising a detachably removable protective cover, wherein the protective cover is configured to overlie a majority of the end effector but not overline the lens of the vision sensor.

26. The humanoid robot of claim 25, wherein the protective cover is configured as a glove with an extent of the glove detachably secured to the end effector.

27. The humanoid robot of claim 21, wherein the vision sensor comprises a first imaging detector, and wherein the head includes a second imaging detector that is identical to the first imaging detector.

28. The humanoid robot of claim 21, wherein the end effector further includes a heat sink positioned at a dorsal side of the end effector.
